(19) United States
(12) Patent Application Publication
(10) Pub. No.: US 2024/0365341 A1
(43) Pub. Date: Oct. 31, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI TUILUO COMMUNICATION TECHNOLOGY PARTNERSHIP (LIMITED PARTNERSHIP), Shanghai (CN)

(21) Appl. No.: 18/769,452

(22) Filed: Jul. 11, 2024

Related U.S. Application Data
(63) Continuation of application No. PCT/CN2023/071132, filed on Jan. 7, 2023.

(30) Foreign Application Priority Data
Jan. 13, 2022 (CN) 202210038913.7

(51) Int. Cl. H04W 72/232; H04L 5/00; H04W 72/1263

(52) U.S. Cl. CPC H04W 72/232; H04L 5/0044; H04W 72/1263

(57) ABSTRACT

The present application discloses a method and a device in a node for wireless communications. A first receiver receives first information and a first DCI, the first DCI comprising a first field; a first transmitter transmits a first bit block on a first wireless channel; herein, the first DCI is used to schedule the first wireless channel, the first field in the first DCI being used to determine one of a frequency-domain resource occupied by the first wireless channel or an MCS used by the first wireless channel; the first information is used to determine whether there is a field in the first DCI that is related to a method of indication of the first field in the first DCI and is used to determine a waveform for the first wireless channel.

### CROSS REFERENCE TO RELATED APPLICATIONS

This application is the continuation of the international patent application No. PCT/CN2023/071132, filed on Jan. 7, 2023, and claims the priority benefit of Chinese Patent Application No. 202210038913.7, filed on Jan. 13, 2022, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In uplink transmission, the use of different physical layer waveforms for different scenarios can effectively improve communication efficiency. Dynamic waveform switching is an effective means to enhance the scheduling performance of the base station side; how to deal with the impact of the introduction of dynamic waveform switching on other scheduling information is a key issue that must be solved to realize dynamic waveform switching.

### SUMMARY

To address the above problem, the present application provides a solution. It should be noted that the above description uses dynamic waveform switching in the uplink as an example; the present application is equally applicable to other scenarios, such as scenarios using semi-static waveform switching, systems supporting the use of multiple physical layer waveforms, sidelink, Internet of Things (IoT), V2X, non-terrestrial networks (NTN), etc. and achieves similar technical results. In addition, the adoption of a unified solution for different scenarios (including, but not limited to, dynamic waveform switching, semi-static waveform switching, systems supporting the use of multiple physical layer waveforms, uplink, sidelink, IoT, V2X, NTN) can also help to reduce the hardware complexity and cost, or to improve the performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving first information and a first DCI, the first DCI comprising a first field; and
transmitting a first bit block on a first wireless channel;
herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one embodiment, an advantage of the above method includes: the flexibility of physical layer waveform selection and the flexibility of frequency-domain resource allocation or MCS selection being jointly optimized to improve the overall scheduling flexibility on the base station side.

In one embodiment, an advantage of the above method includes: reducing constraints on base station side scheduling, which helps enhance system performance.

In one embodiment, an advantage of the above method includes: enhancing control signaling transmission reliability or, alternatively, saving control signaling overhead.

In one embodiment, an advantage of the above method includes: avoiding inappropriate {physical layer waveform, frequency-domain allocation type} combinations.

In one embodiment, an advantage of the above method includes: reducing the delay for realizing the base station side decision at the UE side, which is conducive to the improvement of system efficiency:

In one embodiment, an advantage of the above method includes: helping to reduce PAPR.

In one embodiment, an advantage of the above method includes: helping to save the transmission power of the UE.

In one embodiment, an advantage of the above method includes: enhancing the transmission performance of the uplink.

In one embodiment, an advantage of the above method includes: reducing interference.

In one embodiment, an advantage of the above method includes: helping to improve spectral efficiency.

According to one aspect of the present application, the above method is characterized in that,
the first information is used to determine whether the first DCI comprises a second field; when the first DCI comprises the second field: the second field in the first DCI is related to the method of indication of the first field in the first DCI and is used to determine the waveform for the first wireless channel.

In one embodiment, an advantage of the above method includes: increasing the flexibility of scheduling.

According to one aspect of the present application, the above method is characterized in that,
the first DCI comprises a first field group, the first field group comprising at least one field, and the first information is used to determine whether the first field group in the first DCI is used to determine the waveform for the first wireless channel; when the first field group in the first DCI is used to determine the waveform for the first wireless channel, the first field group in the first DCI is related to the method of indication of the first field in the first DCI; when the first field group in the first DCI is not used to determine the waveform for the first wireless channel, the first field group in the first DCI is independent of the method of indication of the first field in the first DCI.

In one embodiment, an advantage of the above method includes: reusing existing fields in the DCI format for waveform indication, thus saving overhead in control signaling.

According to one aspect of the present application, the above method is characterized in that,
the first field group in the first DCI comprises a target bit group, and at least one bit in each field included in the first field group in the first DCI belongs to the target bit group; when the first field group in the first DCI is determined to be used for indicating the waveform for the first wireless channel and a value of the target bit group belongs to a first candidate value subset, the method of indication of the first field in the first DCI is a first method of indication; when the first field group in the first DCI is determined to be used for indicating the waveform for the first wireless channel and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

According to one aspect of the present application, the above method is characterized in that,
when the first field group in the first DCI is determined to be used for indicating the waveform for the first wireless channel and the value of the target bit group belongs to a second candidate value subset, the waveform for the first wireless channel is a first waveform; when the first field group in the first DCI is determined to be used for indicating the waveform for the first wireless channel and the value of the target bit group does not belong to the second candidate value subset, the waveform for the first wireless channel is a second waveform; the first waveform and the second waveform are different physical layer waveforms, respectively, the second candidate value subset being a non-empty proper subset of the first candidate value set; the second candidate value subset is a non-empty proper subset of the first candidate value subset, or the first candidate value subset is a non-empty proper subset of the second candidate value subset.

In one embodiment, an advantage of the above method includes: using those unused states of existing fields in the DCI format for waveform indication, thus saving overhead in control signaling.

In one embodiment, characteristics of the above method include: utilizing the unused state of the bits in the first field group for waveform indication, while determining the corresponding default physical layer waveform for the used state of the bits in the first field group; an advantage of the above method includes both saving the overhead of control signaling and ensuring consistency in the understanding of the transmitted waveforms between the two parties of the communication.

In one embodiment, characteristics of the above method include: for the target bit group, the condition for switching between the first waveform and the second waveform is different from the condition for switching between the first method of indication and the second method of indication.

In one embodiment, an advantage of the above method includes: balancing the saving on control signaling overhead with the flexibility in base station scheduling.

In one embodiment, an advantage of the above method includes: performing waveform indication using multiple fields in the DCI, which improves the utilization ratio of bits in the DCI.

In one embodiment, an advantage of the above method includes: by reducing the correlation between the method of indication of the first field in the first DCI and the indication of the waveform for the first wireless channel, thus, scheduling flexibility is improved without affecting scheduling performance.

According to one aspect of the present application, the above method is characterized in that,
the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information belongs to the first parameter value subset, the first field group in the first DCI is related to the method of indication of the first field in the first DCI; when the value of the first information does not belong to the first parameter value subset, the first field group in the first DCI is independent of the method of indication of the first field in the first DCI.

In one embodiment, an advantage of the above method includes: increasing the flexibility of scheduling.

In one embodiment, an advantage of the above method includes: making little change to existing specifications with the introduction of dynamic waveform switching.

According to one aspect of the present application, the above method is characterized in that,
the first field group in the first DCI comprises a target bit group, and at least one bit in each field included in the first field group in the first DCI belongs to the target bit group; a first given parameter value is one parameter value in the first parameter value subset; when the value of the first information is the first given parameter value and a value of the target bit group belongs to a first candidate value subset, the method of indication of the first field in the first DCI is a first method of indication; when the value of the first information is the first given parameter value and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

The present application provides a method in a second node for wireless communications, comprising:
transmitting first information and a first DCI, the first DCI comprising a first field; and
receiving a first bit block on a first wireless channel;
herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

According to one aspect of the present application, the above method is characterized in that,
the first information is used to determine whether the first DCI comprises a second field; when the first DCI comprises the second field; the second field in the first DCI is related to the method of indication of the first field in the first DCI and is used to determine the waveform for the first wireless channel.

According to one aspect of the present application, the above method is characterized in that,
the first DCI comprises a first field group, the first field group comprising at least one field, and the first information is used to determine whether the first field group in the first DCI is used to determine the waveform for the first wireless channel; when the first field group in the first DCI is used to determine the waveform for the first wireless channel, the first field group in the first DCI is related to the method of indication of the first field in the first DCI; when the first field group in the first DCI is not used to determine the waveform for the first wireless channel, the first field group in the first DCI is independent of the method of indication of the first field in the first DCI.

According to one aspect of the present application, the above method is characterized in that,
the first field group in the first DCI comprises a target bit group, and at least one bit in each field included in the first field group in the first DCI belongs to the target bit group; when the first field group in the first DCI is determined to be used for indicating the waveform for the first wireless channel and a value of the target bit group belongs to a first candidate value subset, the method of indication of the first field in the first DCI is a first method of indication; when the first field group in the first DCI is determined to be used for indicating the waveform for the first wireless channel and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

According to one aspect of the present application, the above method is characterized in that,
when the first field group in the first DCI is determined to be used for indicating the waveform for the first wireless channel and the value of the target bit group belongs to a second candidate value subset, the waveform for the first wireless channel is a first waveform; when the first field group in the first DCI is determined to be used for indicating the waveform for the first wireless channel and the value of the target bit group does not belong to the second candidate value subset, the waveform for the first wireless channel is a second waveform; the first waveform and the second waveform are different physical layer waveforms, respectively; the second candidate value subset being a non-empty proper subset of the first candidate value set; the second candidate value subset is a non-empty proper subset of the first candidate value subset, or the first candidate value subset is a non-empty proper subset of the second candidate value subset.

According to one aspect of the present application, the above method is characterized in that,
the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information belongs to the first parameter value subset, the first field group in the first DCI is related to the method of indication of the first field in the first DCI; when the value of the first information does not belong to the first parameter value subset, the first field group in the first DCI is independent of the method of indication of the first field in the first DCI.

According to one aspect of the present application, the above method is characterized in that,
the first field group in the first DCI comprises a target bit group, and at least one bit in each field included in the first field group in the first DCI belongs to the target bit group; a first given parameter value is one parameter value in the first parameter value subset; when the value of the first information is the first given parameter value and a value of the target bit group belongs to a first candidate value subset, the method of indication of the first field in the first DCI is a first method of indication; when the value of the first information is the first given parameter value and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

The present application provides a first node for wireless communications, comprising:
a first receiver, receiving first information and a first DCI, the first DCI comprising a first field; and
a first transmitter, transmitting a first bit block on a first wireless channel;
herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

The present application provides a second node for wireless communications, comprising:
a second transmitter, transmitting first information and a first DCI, the first DCI comprising a first field; and
a second receiver, receiving a first bit block on a first wireless channel;
herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

The present application provides a method in a first node for wireless communications, comprising:
receiving first information and a first DCI; and
transmitting a first bit block on a first wireless channel;
herein, the first DCI is used to schedule the first wireless channel; the first information is used to determine a resource allocation type used for the first wireless channel; whether the first node supports the presence of a field in the first DCI being used to determine the waveform for the first wireless channel is related to a value of the first information; when the value of the first information denotes using resource allocation type 0; the first node does not support the presence of the field in the first DCI being used to determine the waveform for the first wireless channel.

In one embodiment, an advantage of the above method includes: helping to reduce PAPR.

In one embodiment, an advantage of the above method includes: helping to save the transmission power of the UE.

In one embodiment, an advantage of the above method includes: enhancing the transmission performance of the uplink.

In one embodiment, an advantage of the above method includes: reducing interference.

In one embodiment, an advantage of the above method includes: avoiding inappropriate {physical layer waveform, frequency-domain allocation type} combinations.

According to one aspect of the present application, the above method is characterized in that,
the first DCI comprises a first field, the first field in the first DCI being used to determine frequency-domain resources occupied by the first wireless channel.

According to one aspect of the present application, the above method is characterized in that,
the first DCI belongs to DCIs of a first type; whether the first node supports the presence of a field in the DCIs of the first type being used to determine the waveform for the first wireless channel is related to a value of the first information; when the value of the first information denotes using resource allocation type 0: the first node does not support the presence of the field in the DCIs of the first type being used to determine the waveform for the first wireless channel.

According to one aspect of the present application, the above method is characterized in that,
DCIs that use DCI format 0_1 all belong to the DCIs of the first type.

According to one aspect of the present application, the above method is characterized in that,
DCIs that use DCI format 0_2 all belong to the DCIs of the first type.

According to one aspect of the present application, the above method is characterized in that,
when the value of the first information denotes using resource allocation type 1: the first node supports the presence of the field in the first DCI being used to determine the waveform for the first wireless channel.

According to one aspect of the present application, the above method is characterized in that,
when the value of the first information denotes a first field being used to indicate a resource allocation type: the first node supports the presence of the field in the first DCI being used to determine the waveform for the first wireless channel.

According to one aspect of the present application, the above method is characterized in that,
when the value of the first information denotes a first field being used to indicate a resource allocation type: the first node does not support the presence of the field in the first DCI being used to determine the waveform for the first wireless channel.

According to one aspect of the present application, the above method is characterized in that,
when the value of the first information denotes using resource allocation type 1: the first node supports the presence of the field in the DCIs of the first type being used to determine the waveform for the first wireless channel.

According to one aspect of the present application, the above method is characterized in that, when the value of the first information denotes a first field being used to indicate a resource allocation type: the first node supports the presence of the field in the DCIs of the first type being used to determine the waveform for the first wireless channel.

According to one aspect of the present application, the above method is characterized in that, when the value of the first information denotes a first field being used to indicate a resource allocation type: the first node does not support the presence of the field in the DCIs of the first type being used to determine the waveform for the first wireless channel.

The present application provides a first node for wireless communications, comprising:
a first receiver, receiving first information and a first DCI; and
a first transmitter, transmitting a first bit block on a first wireless channel;
herein, the first DCI is used to schedule the first wireless channel; the first information is used to determine a resource allocation type used for the first wireless channel; whether the first node supports the presence of a field in the first DCI being used to determine the waveform for the first wireless channel is related to a value of the first information; when the value of the first information denotes using resource allocation type 0: the first node does not support the presence of the field in the first DCI being used to determine the waveform for the first wireless channel.

According to one aspect of the present application, the above node is characterized in that,
the first DCI comprises a first field, the first field in the first DCI being used to determine frequency-domain resources occupied by the first wireless channel.

According to one aspect of the present application, the above node is characterized in that,
the first DCI belongs to DCIs of a first type: whether the first node supports the presence of a field in the DCIs of the first type being used to determine the waveform for the first wireless channel is related to a value of the first information; when the value of the first information denotes using resource allocation type 0: the first node does not support the presence of the field in the DCIs of the first type being used to determine the waveform for the first wireless channel.

According to one aspect of the present application, the above node is characterized in that,
DCIs that use DCI format 0_1 all belong to the DCIs of the first type.

According to one aspect of the present application, the above node is characterized in that,
DCIs that use DCI format 0_2 all belong to the DCIs of the first type.

According to one aspect of the present application, the above node is characterized in that,
when the value of the first information denotes using resource allocation type 1: the first node supports the presence of the field in the first DCI being used to determine the waveform for the first wireless channel.

According to one aspect of the present application, the above node is characterized in that,
when the value of the first information denotes a first field being used to indicate a resource allocation type: the first node supports the presence of the field in the first DCI being used to determine the waveform for the first wireless channel.

According to one aspect of the present application, the above node is characterized in that,
when the value of the first information denotes a first field being used to indicate a resource allocation type: the first node does not support the presence of the field in the first DCI being used to determine the waveform for the first wireless channel.

According to one aspect of the present application, the above node is characterized in that,
when the value of the first information denotes using resource allocation type 1: the first node supports the presence of the field in the DCIs of the first type being used to determine the waveform for the first wireless channel.

According to one aspect of the present application, the above node is characterized in that,
when the value of the first information denotes a first field being used to indicate a resource allocation type: the first node supports the presence of the field in the DCIs of the first type being used to determine the waveform for the first wireless channel.

According to one aspect of the present application, the above node is characterized in that,
when the value of the first information denotes a first field being used to indicate a resource allocation type: the first node does not support the presence of the field in the DCIs of the first type being used to determine the waveform for the first wireless channel.

In one embodiment, the method in the present application has the following advantages:
enhanced uplink transmission performance;
reduced constraints on base station side scheduling, which benefits the enhancement of system performance;
improved flexibility of scheduling;
beneficial to saving UE transmission power;
conducive to reducing interference;
conducive to reducing the overhead of control signaling.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of signal transmission according to one embodiment of the present application.

FIG. 6 illustrates a schematic diagram of the relationship between a number of bits included in a first field in a first DCI and a method of indication of the first field in the first DCI according to one embodiment of the present application.

FIG. 7 illustrates a schematic diagram of the relationship among first information, a first DCI, a second field, a method of indication of the first field in the first DCI, and a waveform for the first wireless channel according to one embodiment of the present application.

FIG. 8 illustrates a schematic diagram of the relationship among first information, a first DCI, a first field group in the first DCI, a method of indication of the first field in the first DCI, and a waveform for the first wireless channel according to one embodiment of the present application.

FIG. 9 illustrates a schematic diagram of the relationship among a first field group in a first DCI, a target bit group and a method of indication of the first field in the first DCI according to one embodiment of the present application.

FIG. 10 illustrates a schematic diagram of the relationship among a first field group in a first DCI, a target bit group and a waveform for the first wireless channel according to one embodiment of the present application.

FIG. 11 illustrates a schematic diagram of the relationship among a first node, second information as well as a first DCI comprising a first field group according to one embodiment of the present application.

FIG. 12 illustrates a schematic diagram of the relationship among first information, a first field group in a first DCI, and a method of indication of the first field in the first DCI according to one embodiment of the present application.

FIG. 13 illustrates a schematic diagram explaining a first node and associated configurations of a first DCI according to one embodiment of the present application.

FIG. 14 illustrates a schematic diagram of the relationship among first information, a first field group in a first DCI, a target bit group and a method of indication of the first field in the first DCI according to one embodiment of the present application.

FIG. 15 illustrates a flowchart of processing of a first node according to one embodiment of the present application.

FIG. 16 illustrates a flowchart of signal transmission according to one embodiment of the present application.

FIG. 17 illustrates a structure block diagram of a processing device in a first node according to one embodiment of the present application.

FIG. 18 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

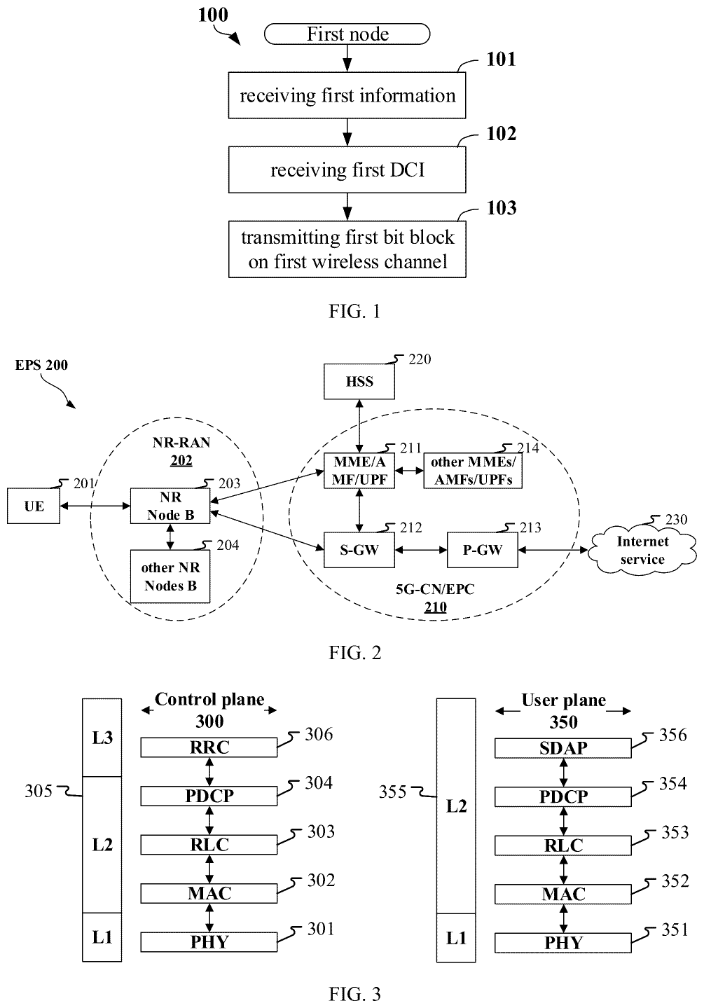

Embodiment 1 illustrates a flowchart of processing of a first node according to one embodiment of the present application, as shown in FIG. 1.

In Embodiment 1, the first node in the present application receives first information in step 101; receives a first DCI in step 102; and transmits a first bit block on a first wireless channel in step 103.

In Embodiment 1, the first DCI comprises a first field; the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one embodiment, the first information is a physical layer signaling.

In one embodiment, the first information is a Downlink control information (DCI) format.

In one embodiment, the first information is a DCI other than the first DCI.

In one embodiment, the first information does not belong to the first DCI.

In one embodiment, the first information is DCI format 0_0, for the specific definition of the DCI format 0_0, refer to Section 7.3.1.1 of 3GPP TS 38.212.

In one embodiment, the first information is DCI format 0_1, for the specific definition of the DCI format 0_1, refer to Section 7.3.1.1 of 3GPP TS 38.212.

In one embodiment, the first information is DCI format 0_2, for the specific definition of the DCI format 0_2, refer to Section 7.3.1.1 of 3GPP TS 38.212.

In one embodiment, the first information is DCI format 1_0, for the specific definition of the DCI format 1_0, refer to Section 7.3.1.2 of 3GPP TS 38.212.

In one embodiment, the first information is DCI format 1_1, for the specific definition of the DCI format 1_1, refer to Section 7.3.1.2 of 3GPP TS 38.212.

In one embodiment, the first information is DCI format 1_2, for the specific definition of the DCI format 1_2, refer to Section 7.3.1.2 of 3GPP TS 38.212.

In one embodiment, the first information comprises one or more fields in a DCI format.

In one embodiment, the first information is a higher layer signaling.

In one embodiment, the first information is an RRC signaling.

In one embodiment, the first information comprises one or more fields in an RRC signaling.

In one embodiment, the first information comprises one Information Element (IE).

In one embodiment, the first information comprises one or more fields in an IE.

In one embodiment, the first information is a Medium Access Control layer Control Element (MAC CE).

In one embodiment, the first information comprises one or more fields in a MAC CE.

In one embodiment, the first information belongs to an IE PUSCH-Config.

In one embodiment, the first information comprises an IE PUSCH-Config.

In one embodiment, the first information is an IE PUSCH-Config.

In one embodiment, the first DCI is a physical layer signaling.

In one embodiment, the first DCI is a DCI format.

In one embodiment, the first DCI is a DCI signaling.

In one embodiment, the first node receives the first DCI in a physical layer control channel.

In one embodiment, the first node receives the first DCI in a Physical downlink control channel (PDCCH).

In one embodiment, the first DCI is DCI format 0_0, for the specific definition of the DCI format 0_0, refer to Section 7.3.1.1 of 3GPP TS 38.212.

In one embodiment, the first DCI is DCI format 0_1, for the specific definition of the DCI format 0_1, refer to Section 7.3.1.1 of 3GPP TS 38.212.

In one embodiment, the first DCI is DCI format 0_2, for the specific definition of the DCI format 0_2, refer to Section 7.3.1.1 of 3GPP TS 38.212.

In one embodiment, the first DCI uses DCI format 0_0.

In one embodiment, the first DCI uses DCI format 0_1.

In one embodiment, the first DCI uses DCI format 0_2.

In one embodiment, the first DCI uses one of DCI format 0_0, DCI format 0_1 or DCI format 0_2.

In one embodiment, the first DCI uses one of DCI format 0_1 or DCI format 0_2.

In one embodiment, the first DCI is an UpLink Grant Signaling.

In one embodiment, a Cyclic redundancy check (CRC) of the first DCI is scrambled by an MCS-C-RNTI.

In one embodiment, a CRC of the first DCI is scrambled by a C-RNTI or SP-CSI-RNTI.

In one embodiment, a CRC of the first DCI is scrambled by a CS-RNTI.

In one embodiment, a mcs-TableTransformPrecoder field in a pusch-Config signaling received by the first node is set to qam64LowSE.

In one embodiment, the first field consists of at least one bit.

In one embodiment, the first field comprises multiple bits.

In one embodiment, the first field consists of 5 bits.

In one embodiment, the number of bits included in the first field is configurable.

In one embodiment, the number of bits included in the first field is related to a size of an activated UL BWP or a total number of Resource block groups (RBGs) of the UL BWP.

In one embodiment, the first field is a Frequency domain resource assignment field.

In one embodiment, the first field is a Modulation and coding scheme (MCS) field.

In one embodiment, a number of bits included in the first field in the first DCI is independent of the method of indication of the first field in the first DCI.

In one embodiment, the first wireless channel is a Physical Uplink Shared CHannel (PUSCH).

In one embodiment, the first wireless channel is a Physical Uplink Control CHannel (PUCCH).

In one embodiment, the first wireless channel is an uplink channel.

In one embodiment, the first wireless channel is a physical layer channel.

In one embodiment, the first bit block comprises multiple bits.

In one embodiment, the first bit block comprises bits of an Uplink shared channel (UL-SCH).

In one embodiment, the first bit block comprises a Transport Block.

In one embodiment, the first bit block comprises 2 Transport Blocks.

In one embodiment, the first bit block comprises Channel state information (CSI) bits.

In one embodiment, at least the first bit block, after being through at least part of CRC attachment, Code block segmentation, Code block CRC attachment, Channel coding, Rate matching, Code block concatenation, Scrambling, Modulation, Layer mapping, Transform precoding, Precoding, Resource block mapping, Multicarrier symbol generation, and Modulation and Upconversion, is transmitted on the first wireless channel.

In one embodiment, the first bit block is transmitted on the first channel after being through at least part of CRC attachment, Code block segmentation, Code block CRC attachment, Channel coding, Rate matching, Code block concatenation, Scrambling, Modulation, Layer mapping, Transform precoding, Precoding, Mapping to virtual resource blocks, and Mapping from virtual to physical resource blocks.

In one embodiment, the first bit block is transmitted on the first wireless channel after being through at least channel coding.

In one embodiment, a signal transmitted on the first wireless channel carries the first bit block.

In one embodiment, the first DCI comprises scheduling information of the first wireless channel.

In one embodiment, the first DCI is used to indicate scheduling information of the first wireless channel.

In one embodiment, the scheduling information in the present application comprises at least one of {occupied time domain resources, occupied frequency domain resources, antenna ports used, a Modulation and coding scheme (MCS) used, a redundancy version (RV) used, precoding used, corresponding priority; associated Sounding reference signal (SRS) resources}.

In one embodiment, the first field in the first DCI is at least used to indicate a frequency domain resource occupied by the first wireless channel.

In one embodiment, the first field in the first DCI explicitly indicates a frequency domain resource occupied by the first wireless channel.

In one embodiment, the first field in the first DCI is used to indicate a Physical resource block (PRB) occupied by the first wireless channel in frequency domain.

In one embodiment, the first field in the first DCI implicitly indicates a frequency domain resource occupied by the first wireless channel.

In one embodiment, the first field in the first DCI is used to indicate an MCS used by the first wireless channel.

In one embodiment, the first field in the first DCI explicitly indicates an MCS used by the first wireless channel.

In one embodiment, the first field in the first DCI implicitly indicates an MCS used by the first wireless channel.

In one embodiment, the first field in the first DCI is used to indicate an MCS used by the first wireless channel from an MCS index table.

In one embodiment, the higher layer parameter useInterlacePUCCH-PUSCH is not configured.

In one embodiment, the statement “being used to determine the waveform for the first wireless channel” in the present application and “being used to indicate whether transform precoding is enabled” are equivalent or interchangeable.

In one embodiment, the statement “being used to determine the waveform for the first wireless channel” in the present application and “being used to indicate whether transform precoding is enabled for signal transmitting on the first wireless channel” are equivalent or interchangeable.

In one embodiment, the transform precoding in the present application is described in Section 6.3.1.4 of 3GPP TS 38.211.

In one embodiment, the transform precoding in the present application is related to a DFT operation.

In one embodiment, the implementation of the transform precoding in the present application is predefined.

In one embodiment, the statement “a method of indication of the first field in the first DCI” comprises: the meaning of at least one bit of the first field in the first DCI.

In one embodiment, the statement “a method of indication of the first field in the first DCI” comprises: the meaning of Most Significant Bit (MSB) of the first field in the first DCI.

In one embodiment, the statement “a method of indication of the first field in the first DCI” comprises: the interpretation of MSB of the first field in the first DCI.

In one embodiment, the statement “a method of indication of the first field in the first DCI” comprises: whether an MSB of the first field in the first DCI being used to indicate a resource allocation type.

In one embodiment, the statement “a method of indication of the first field in the first DCI” comprises: whether an MSB of the first field in the first DCI being used to indicate a frequency domain resource allocation type.

In one embodiment, the frequency domain resource allocation type indicated by the first DCI is one of resource allocation type 0 or resource allocation type 1.

In one embodiment, the frequency domain resource allocation type indicated by the first DCI is one of frequency domain resource allocation indicated using a bitmap or continuous frequency domain resource allocations.

In one embodiment, the frequency domain resource allocation type indicated by the first DCI is one of RBG allocation indicated using a bitmap or continuous RB allocations.

In one embodiment, the frequency domain resource allocation type indicated by the MSB of the first field in the first DCI is one of resource allocation type 0 or resource allocation type 1.

In one embodiment, the frequency domain resource allocation type indicated by the MSB of the first field in the first DCI is one of frequency domain resource allocation indicated using a bitmap or continuous frequency domain resource allocations.

In one embodiment, the frequency domain resource allocation type indicated by the MSB of the first field in the first DCI is one of RBG allocation indicated using a bitmap or continuous RB allocations.

In one embodiment, the statement “a method of indication of the first field in the first DCI” comprises: whether the first field in the first DCI being used to indicate frequency domain resources according to the resource allocation type 0 or the resource allocation type 1.

In one embodiment, the statement “a method of indication of the first field in the first DCI” comprises: the resource allocation type targeted by the frequency domain resource allocation indicated by the first field in the first DCI.

In one embodiment, the statement “a method of indication of the first field in the first DCI” comprises: the first field in the first DCI being used to indicate, from which MCS index table, the MCS used by the first wireless channel.

In one embodiment, the statement “a method of indication of the first field in the first DCI” comprises: an MCS index table on which the indication of an MCS from the first field in the first DCI is based.

In one embodiment, the statement “a method of indication of the first field in the first DCI” comprises:

a modulation scheme corresponding to an MCS index indicated by the first field in the first DCI in an MCS index table.

In one embodiment, the statement “related to a method of indication of the first field in the first DCI” comprises: being used to determine a method of indication of the first field in the first DCI.

In one embodiment, the statement “related to the method of indication of the first field in the first DCI” in the present application comprises: being used to determine the method of indication of the first field in the first DCI.

In one embodiment, the statement “the first information is used to determine whether there is a field in the first DCI that is related to a method of indication of the first field in the first DCI and is used to determine a waveform for the first wireless channel” includes that
the first information is used to determine whether the first DCI comprises a second field: when the first DCI comprises the second field: the second field in the first DCI is related to a method of indication of the first field in the first DCI and is used to determine a waveform for the first wireless channel.

In one embodiment, the statement “the first information is used to determine whether there is a field in the first DCI that is related to a method of indication of the first field in the first DCI and is used to determine a waveform for the first wireless channel” includes that
the first DCI comprises a first field group, the first field group comprising at least one field, the first field group in the first DCI being used to determine a waveform for the first wireless channel; the first information is used to determine whether the first field group in the first DCI is related to the method of indication of the first field in the first DCI.

In one embodiment, the first information is used to indicate whether the first field group in the first DCI is related to the method of indication of the first field in the first DCI.

In one embodiment, whether the first field group in the first DCI is related to the method of indication of the first field in the first DCI is determined based on the configuration of the first information.

In one embodiment, the waveform for the first wireless channel is one of a DFT-s-OFDM waveform or a CP-OFDM waveform.

In one embodiment, the statement “the first information is used to determine whether there is a field in the first DCI that is related to a method of indication of the first field in the first DCI and is used to determine a waveform for the first wireless channel” includes that
the first DCI comprises a first field group, the first field group comprising at least one field, and the first information is used to determine whether the first field group in the first DCI is used to determine the waveform for the first wireless channel; when the first field group in the first DCI is used to determine the waveform for the first wireless channel, the first field group in the first DCI is related to the method of indication of the first field in the first DCI; when the first field group in the first DCI is not used to determine the waveform for the first wireless channel, the first field group in the first DCI is independent of the method of indication of the first field in the first DCI.

In one embodiment, the statement “the first information is used to determine whether there is a field in the first DCI that is related to a method of indication of the first field in the first DCI and is used to determine a waveform for the first wireless channel” includes that
the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information is any parameter value in the first parameter value subset, the first field group in the first DCI is related to the method of indication of the first field in the first DCI; when the value of the first information is not any parameter value in the first parameter value subset, the first field group in the first DCI is independent of the method of indication of the first field in the first DCI.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, a Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 corresponds to the second node in the present application.

In one embodiment, the gNB 203 corresponds to the first node in the present application.

In one embodiment, the gNB203 corresponds to the second node in the present application.

In one embodiment, the UE 201 corresponds to the first node in the present application, and the gNB203 corresponds to the second node in the present application.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment.

In one embodiment, the first node and the second node in the present application both correspond to the UE 201, for instance, V2X communications is performed between the first node and the second node.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information in the present application is generated by the RRC sublayer 306.

In one embodiment, the first information in the present application is generated by the MAC sublayer 302.

In one embodiment, the first information in the present application is generated by the MAC sublayer 352.

In one embodiment, the first information in the present application is generated by the PHY 301.

In one embodiment, the first information in the present application is generated by the PHY 351.

In one embodiment, the second information in the present application is generated by the RRC sublayer 306.

In one embodiment, the second information in the present application is generated by the MAC sublayer 302.

In one embodiment, the second information in the present application is generated by the MAC sublayer 352.

In one embodiment, the second information in the present application is generated by the PHY 301.

In one embodiment, the second information in the present application is generated by the PHY 351.

In one embodiment, the first DCI in the present application is generated by the PHY 301.

In one embodiment, the first DCI in the present application is generated by the PHY 351.

In one embodiment, the first bit block in the present application is generated by the SDAP sublayer 356.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

### Embodiment 4

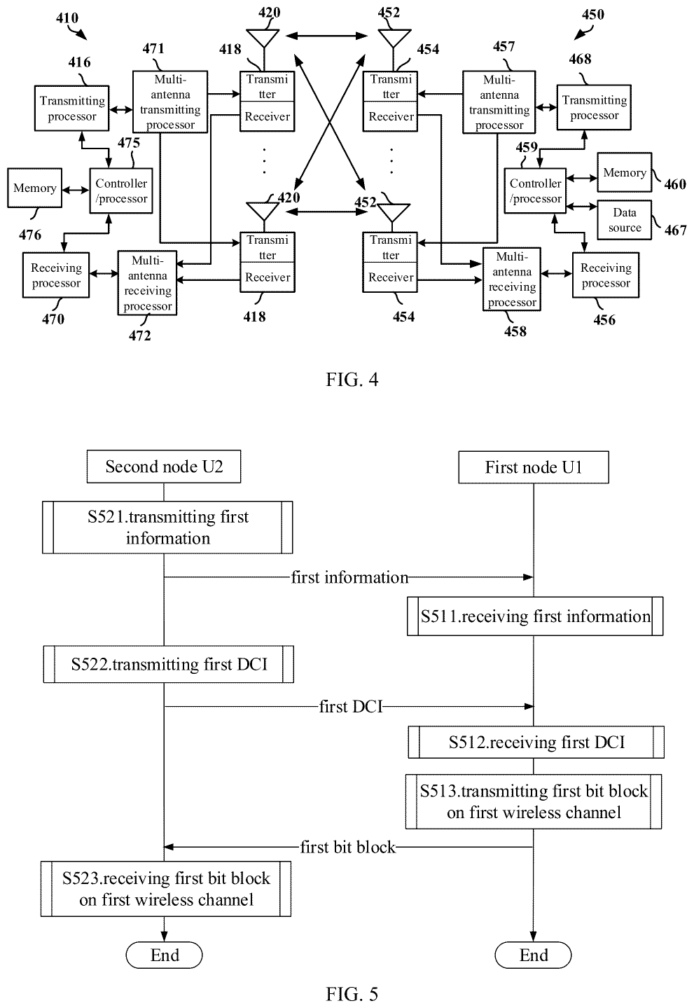

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also responsible for a retransmission of a lost packet, and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also in charge of a retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second node is a UE, and the first node is a base station.

In one subembodiment, the second node is a relay node, and the first node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory. The at least one memory comprises computer program codes: the at least one memory and the computer program codes are configured to be used in collaboration with the at least one processor. The second communication device 450 at least receives first information and a first DCI, the first DCI comprising a first field; and transmits a first bit block on a first wireless channel; herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one subembodiment, the second communication device 450 corresponds to the first node in the present application.

In one embodiment, the second communication device 450 comprises a memory that stores a computer readable instruction program. The computer readable instruction program generates actions when executed by at least one processor. The actions include: receiving first information and a first DCI, the first DCI comprising a first field; and transmitting a first bit block on a first wireless channel; herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one subembodiment, the second communication device 450 corresponds to the first node in the present application.

In one embodiment, the first communication device 410 comprises at least one processor and at least one memory. The at least one memory comprises computer program codes: the at least one memory and the computer program codes are configured to be used in collaboration with the at least one processor. The first communication device 410 at least transmits first information and a first DCI, the first DCI comprising a first field; and receives a first bit block on a first wireless channel; herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one subembodiment, the first communication device 410 corresponds to the second node in the present application.

In one embodiment, the first communication device 410 comprises a memory that stores a computer readable instruction program. The computer readable instruction program generates actions when executed by at least one processor. The actions include: transmitting first information and a first DCI, the first DCI comprising a first field; and receiving a first bit block on a first wireless channel; herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one subembodiment, the first communication device 410 corresponds to the second node in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives first information and a first DCI; and transmits a first bit block on a first wireless channel; herein, the first DCI is used to schedule the first wireless channel; the first information is used to determine a resource allocation type used for the first wireless channel; whether the first node supports the presence of a field in the first DCI being used to determine the waveform for the first wireless channel is related to a value of the first information; when the value of the first information denotes using resource allocation type 0: the first node does not support the presence of the field in the first DCI being used to determine the waveform for the first wireless channel.

In one subembodiment, the second communication device 450 corresponds to the first node in the present application.

In one embodiment, the second communication device 450 comprises a memory that stores a computer readable instruction program. The computer readable instruction program generates actions when executed by at least one processor. The actions include: receiving first information and a first DCI; and transmitting a first bit block on a first wireless channel; herein, the first DCI is used to schedule the first wireless channel; the first information is used to determine a resource allocation type used for the first wireless channel; whether the first node supports the presence of a field in the first DCI being used to determine the waveform for the first wireless channel is related to a value of the first information; when the value of the first information denotes using resource allocation type 0: the first node does not support the presence of the field in the first DCI being used to determine the waveform for the first wireless channel.

In one subembodiment, the second communication device 450 corresponds to the first node in the present application.

In one embodiment, at least one of the antenna 452, the receiver 454, the multi-antenna receiving processor 458, the receiving processor 456, the controller/processor 459, the memory 460, or the data source 467 is used for receiving the first information in the present application.

In one embodiment, at least one of the antenna 420, the transmitter 418, the multi-antenna transmitting processor 471, the transmitting processor 416, the controller/processor 475 or the memory 476 is used for transmitting the first information in the present application.

In one embodiment, at least one of the antenna 452, the receiver 454, the multi-antenna receiving processor 458, the receiving processor 456, the controller/processor 459, the memory 460, or the data source 467 is used for receiving the first DCI in the present application.

In one embodiment, at least one of the antenna 420, the transmitter 418, the multi-antenna transmitting processor 471, the transmitting processor 416, the controller/processor 475 or the memory 476 is used for transmitting the first DCI in the present application.

In one embodiment, at least one of the antenna 452, the receiver 454, the multi-antenna receiving processor 458, the receiving processor 456, the controller/processor 459, the memory 460, or the data source 467 is used for receiving the second information in the present application.

In one embodiment, at least one of the antenna 420, the transmitter 418, the multi-antenna transmitting processor 471, the transmitting processor 416, the controller/processor 475 or the memory 476 is used for transmitting the second information in the present application.

In one embodiment, at least one of the antenna 452, the transmitter 454, the multi-antenna transmitting processor 458, the transmitting processor 468, the controller/processor 459, the memory 460 or the data source 467 is used for transmitting the first bit block in the present application.

In one embodiment, at least one of the antenna 420, the receiver 418, the multi-antenna receiving processor 472, the receiving processor 470, the controller/processor 475, or the memory 476 is used for receiving the first bit block in the present application.

### Embodiment 5

Embodiment 5 illustrates a flowchart of signal transmission according to one embodiment of the present application, as shown in FIG. 5. In FIG. 5, a first node U1 and a second node U2 are in communications via an air interface.

The first node U1 receives first information in step S511; receives a first DCI in step S512; and transmits a first bit block on a first wireless channel in step S513.

The second node U2 transmits first information in step S521; transmits a first DCI in step S522; and receives a first bit block on a first wireless channel in step S523.

In Embodiment 5, the first DCI comprises a first field; the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one subembodiment of Embodiment 5, the first information is used to determine whether the first DCI comprises a second field; when the first DCI comprises the second field; the second field in the first DCI is related to the method of indication of the first field in the first DCI and is used to determine the waveform for the first wireless channel.

In one subembodiment of Embodiment 5, the first DCI comprises a first field group, the first field group comprising at least one field, and the first information is used to determine whether the first field group in the first DCI is used to determine the waveform for the first wireless channel; when the first field group in the first DCI is used to determine the waveform for the first wireless channel, the first field group in the first DCI is related to the method of indication of the first field in the first DCI; when the first field group in the first DCI is not used to determine the waveform for the first wireless channel, the first field group in the first DCI is independent of the method of indication of the first field in the first DCI; the first field group in the first DCI comprises a target bit group, and at least one bit in each field included in the first field group in the first DCI belongs to the target bit group; when the first field group in the first DCI is determined to be used for indicating the waveform for the first wireless channel and a value of the target bit group belongs to a first candidate value subset, the method of indication of the first field in the first DCI is a first method of indication; when the first field group in the first DCI is determined to be used for indicating the waveform for the first wireless channel and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one subembodiment of Embodiment 5, the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information belongs to the first parameter value subset, the first field group in the first DCI is related to the method of indication of the first field in the first DCI; when the value of the first information does not belong to the first parameter value subset, the first field group in the first DCI is independent of the method of indication of the first field in the first DCI; the first field group in the first DCI comprises a target bit group, and at least one bit in each field included in the first field group in the first DCI belongs to the target bit group; a first given parameter value is one parameter value in the first parameter value subset; when the value of the first information is the first given parameter value and a value of the target bit group belongs to a first candidate value subset, the method of indication of the first field in the first DCI is a first method of indication; when the value of the first information is the first given parameter value and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 includes a cellular link.

In one embodiment, an air interface between the second node U2 and the first node U1 is a PC5 interface.

In one embodiment, an air interface between the second node U2 and the first node U1 includes a sidelink.

In one embodiment, an air interface between the second node U2 and the first node U1 includes a radio interface between a base station and a UE.

In one embodiment, an air interface between the second node U2 and the first node U1 includes a radio interface between a satellite device and a UE.

In one embodiment, an air interface between the second node U2 and the first node U1 includes a radio interface between a UE and another UE.

In one embodiment, a problem to be solved in the present application includes: how to determine an interpretation of a frequency-domain resource allocation field in a DCI based on a waveform-related configuration.

In one embodiment, a problem to be solved in the present application includes: how to determine an MCS index table being used based on a waveform-related configuration.

In one embodiment, a problem to be solved in the present application includes: how to deal with the relationship between the indication of the waveform and the indication of the frequency-domain resource allocation or the indication of the MCS.

In one embodiment, a problem to be solved in the present application includes: how to realize the function of dynamic switching of waveforms.

In one embodiment, a problem to be solved in the present application includes: how to enhance the indication function of the DCI.

In one embodiment, a problem to be solved in the present application includes: how to coordinate the indications of different scheduling information in the same DCI.

In one embodiment, a problem to be solved in the present application includes: how to ensure the scheduling flexibility of the DCI after the introduction of the function of dynamic switching of waveforms.

### Embodiment 6

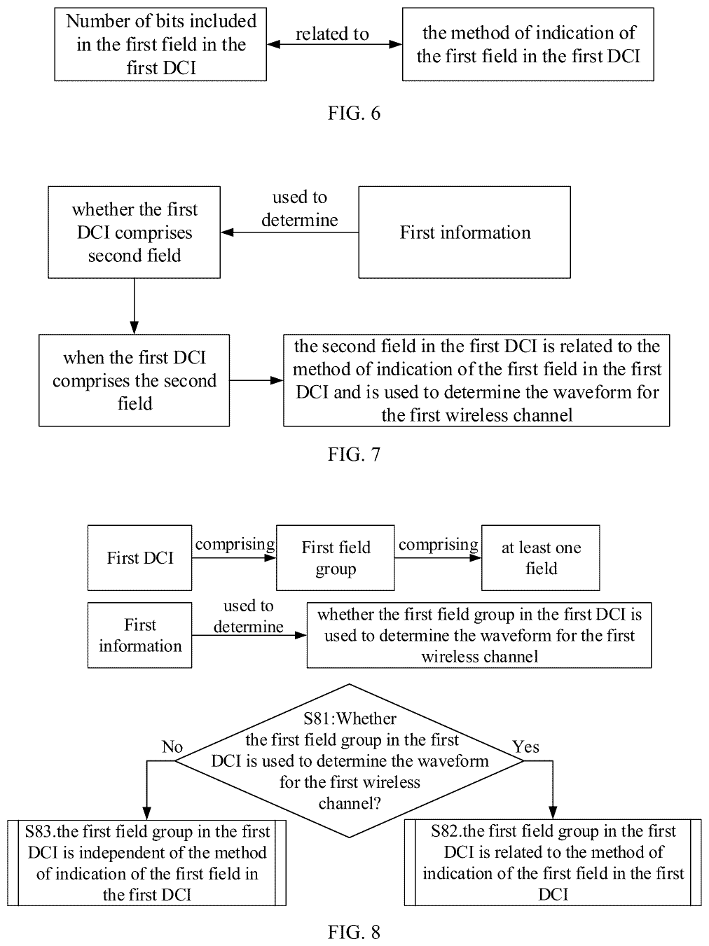

Embodiment 6 illustrates a schematic diagram of the relationship between a number of bits included in a first field in a first DCI and a method of indication of the first field in the first DCI according to one embodiment of the present application, as shown in FIG. 6.

In Embodiment 6, a number of bits included in the first field in the first DCI is related to the method of indication of the first field in the first DCI.

In one embodiment, when an MSB of the first field in the first DCI is used to indicate a frequency domain resource allocation type, a number of bits included in the first field in the first DCI is equal to max {first numerical value, second numerical value}+1: when the MSB of the first field in the first DCI is not used to indicate a frequency domain resource allocation type, the number of bits included in the first field in the first DCI is equal to one of the first numerical value or the second numerical value; the first numerical value is related to a size of an activated UL BWP, and the second numerical value is equal to a total number of RBGs of the UL BWP.

In one embodiment, a size of an activated UL BWP is used to determine the first numerical value.

In one embodiment, the first numerical value is equal to ┌log₂(N_{RB}^{UL,BWP}(N_{RB}^{UL,BWP}+1)/2)┐, and the N_{RB}^{UL,BWP} indicates a size of an activated UL BWP.

In one embodiment, the first numerical value is equal to ┌log₂(N_{RBG,K1} (N_{RBG,K1}+1)/2)┐, the N_{RBG,K1}=┌(N_{RB}^{UL,BWP}+(N_{UL,BWP}^{start} mod K1))/K1┐, the N_{RB}^{UL,BWP} denotes a size of an activated UL BWP, the N_{UL,BWP}^{start} is a starting common resource block relative to common resource block 0 in the activated UL BWP, K1 being configurable.

In one subembodiment, K1 is given by a higher layer parameter resourceAllocationType1GranularityDCI-0-2; if the higher layer parameter resourceAllocationType1GranularityDCI-0-2 is not configured, K1 is equal to 1.

In one embodiment, the first numerical value is linearly related to the size of the activated UL BWP.

In one embodiment, the second numerical value is equal to the total number of RBGs included in the activated UL BWP.

In one embodiment, the method of indication of the first field in the first DCI implicitly indicates a number of bits included in the first field in the first DCI.

In one embodiment, a number of bits included in the first field in the first DCI implicitly indicates the method of indication of the first field in the first DCI.

In one embodiment, when the first field in the first DCI is used to indicate a frequency-domain resource in accordance with resource allocation type 1, the number of bits included in the first field in the first DCI is equal to a first numerical value; when the first field in the first DCI is used to indicate a frequency-domain resource in accordance with resource allocation type 0, the number of bits included in the first field in the first DCI is equal to a second numerical value; the first numerical value is related to the size of an activated uplink bandwidth part (UL BWP) and the second numerical value is equal to a total number of RBGs of the UL BWP.

### Embodiment 7

Embodiment 7 illustrates a schematic diagram of the relationship among first information, a first DCI, a second field, a method of indication of the first field in the first DCI, and a waveform for the first wireless channel according to one embodiment of the present application, as shown in FIG. 7.

In Embodiment 7, the first information is used to determine whether the first DCI comprises a second field; when the first DCI comprises the second field: the second field in the first DCI is related to the method of indication of the first field in the first DCI and is used to determine the waveform for the first wireless channel.

In one embodiment, there does not exist any field other than the second field in the first DCI being used to determine the waveform for the first wireless channel.

In one embodiment, the first information indicates whether the first DCI includes the second field.

In one embodiment, the first information explicitly indicates whether the first DCI includes the second field.

In one embodiment, the first information implicitly indicates whether the first DCI includes the second field.

In one embodiment, whether the first information includes a target field is used to determine whether the first DCI includes the second field, the target field being an optional field.

In one embodiment, when the first information includes a target field, the first DCI includes the second field; when the first information does not include a target field, the first DCI does not include the second field; the target field is an optional field.

In one embodiment, when the first information does not include a target field, the first DCI includes the second field; when the first information does not include a target field, the first DCI includes the second field; the target field is an optional field.

In one embodiment, the target field is a field in an information element.

In one embodiment, the target field is a field being used for carrying an RRC message.

In one embodiment, the second field consists of at least one bit.

In one embodiment, the second field comprises multiple bits.

In one embodiment, the second field consists of 1 bit.

In one embodiment, the second field consists of 2 bits.

In one embodiment, the number of bits included in the second field is configurable.

In one embodiment, a name of the second field includes waveform (not case-sensitive).

In one embodiment, a name of the second field includes at least one of transform or precoding or precoder or Transform or Precoding or Precoder.

In one embodiment, a name of the second field includes transform precoding (not case sensitive).

In one embodiment, a name of the second field includes transform precoder (not case sensitive).

In one embodiment, when the first DCI includes the second field and a value of the second field in the first DCI belongs to a target candidate value subset, the MSB of the first field in the first DCI is used to indicate a frequency domain resource allocation type, and the waveform for the first wireless channel is a first waveform; when the first DCI includes the second field and the value of the second field in the first DCI does not belong to a target candidate value subset, the MSB of the first field in the first DCI is not used to indicate a frequency domain resource allocation type, and the waveform for the first wireless channel is a second waveform; a first candidate value set is a range of values of the second field, and the target candidate value subset is a non-empty proper subset of the first candidate value set.

In one embodiment, when the first DCI includes the second field and a value of the second field in the first DCI belongs to a target candidate value subset, the waveform for the first wireless channel is a first waveform; when the first DCI includes the second field and the value of the second field in the first DCI does not belong to a target candidate value subset, the waveform for the first wireless channel is a second waveform; a first candidate value set is a range of values of the second field, and the target candidate value subset is a non-empty proper subset of the first candidate value set.

In one embodiment, the first waveform and the second waveform are different physical layer waveforms, respectively.

In one embodiment, the first waveform and the second waveform are two different Orthogonal Frequency Division Multiplexing (OFDM) waveforms, respectively.

In one embodiment, the first waveform is one of a Discrete Fourier Transform-spread-OFDM (DFT-s-OFDM) waveform or a Cyclic Prefix-OFDM (CP-OFDM) waveform, and the second waveform is one of a DFT-s-OFDM waveform or a CP-OFDM waveform, the second waveform being different from the first waveform.

In one embodiment, the first waveform is a DFT-s-OFDM waveform and the second waveform is a CP-OFDM waveform.

In one embodiment, the second waveform is a DFT-s-OFDM waveform and the first waveform is a CP-OFDM waveform.

In one embodiment, the statement that “the waveform for the first wireless channel is a first waveform” in the present application and “transform precoding is enabled for signal transmitting on the first wireless channel” are equivalent or interchangeable; the statement that “the waveform for the first wireless channel is a second waveform” in the present application and “transform precoding is not enabled for signal transmitting on the first wireless channel” are equivalent or interchangeable.

In one embodiment, the statement that “the waveform for the first wireless channel is a second waveform” in the present application and “transform precoding is enabled for signal transmitting on the first wireless channel” are equivalent or interchangeable; the statement that “the waveform for the first wireless channel is a first waveform” in the present application and “transform precoding is not enabled for signal transmitting on the first wireless channel” are equivalent or interchangeable.

In one embodiment, based on the configuration of RRC signaling, a resource allocation type being used for the first wireless channel is indicated by the first DCI.

In one embodiment, when the first DCI comprises the second field: at least the second field of the first DCI is used to determine the waveform for the first wireless channel.

In one embodiment, when the first DCI comprises the second field: the second field of the first DCI is used to indicate the waveform for the first wireless channel.

In one embodiment, when the first DCI comprises the second field: the second field of the first DCI is used to indicate whether the waveform for the first wireless channel is a first waveform or a second waveform.

In one embodiment, when the first DCI comprises the second field: the second field of the first DCI is used to indicate whether transform precoding is enabled for signal transmitting on the first wireless channel.

In one embodiment, when the first DCI includes the second field and a value of the second field in the first DCI belongs to a target candidate value subset, the MSB of the first field in the first DCI is used to indicate a frequency domain resource allocation type: when the first DCI includes the second field and the value of the second field in the first DCI does not belong to a target candidate value subset, the MSB of the first field in the first DCI is not used to indicate a frequency domain resource allocation type: a first candidate value set is a range of values of the second field, and the target candidate value subset is a non-empty proper subset of the first candidate value set.

In one embodiment, when the first DCI comprises the second field and a value of the second field in the first DCI belongs to a target candidate value subset, a MSB of the first field in the first DCI is used to indicate a frequency-domain resource allocation type: a first candidate value set is a range of values of the second field, the target candidate value subset being a non-empty proper subset of the first candidate value set.

In one subembodiment, when the first DCI includes the second field and the value of the second field in the first DCI does not belong to the target candidate value subset; the MSB of the first field in the first DCI is used to indicate which resource blocks (RBs) are occupied by the first wireless channel.

In one subembodiment, when the first DCI includes the second field and the value of the second field in the first DCI does not belong to the target candidate value subset; at least one bit of the first field in the first DCI, including the MSB, is used to indicate which resource blocks (RBs) are occupied by the first wireless channel.

In one subembodiment, when the first DCI includes the second field and the value of the second field in the first DCI does not belong to the target candidate value subset; at least one bit of the first field in the first DCI, including the MSB, is used to indicate frequency domain resources occupied by the first wireless channel under the condition that resource allocation type 1 is used.

In one subembodiment, when the first DCI includes the second field and the value of the second field in the first DCI does not belong to the target candidate value subset; at least one bit of the first field in the first DCI, including the MSB, is used to indicate frequency domain resources occupied by the first wireless channel under the condition that resource allocation type 0 is used.

In one subembodiment, when the first DCI includes the second field and the value of the second field in the first DCI does not belong to the target candidate value subset; the MSB of the first field in the first DCI is not used to indicate information related to the frequency domain resources of the first wireless channel.

In one subembodiment, when the first DCI comprises the second field and the value of the second field in the first DCI does not belong to the target candidate value subset; a value of the MSB of the first field in the first DCI is fixed and set to 0.

In one subembodiment, when the first DCI comprises the second field and the value of the second field in the first DCI does not belong to the target candidate value subset; a value of the MSB of the first field in the first DCI is fixed and set to 1.

In one subembodiment, when the first DCI comprises the second field and the value of the second field in the first DCI does not belong to the target candidate value subset; the first node does not support a value of the MSB of the first field in the first DCI being set to 0.

In one subembodiment, when the first DCI comprises the second field and the value of the second field in the first DCI does not belong to the target candidate value subset; the first node does not support a value of the MSB of the first field in the first DCI being set to 1.

In one embodiment, the first candidate value set comprises multiple values expressed in bits.

In one embodiment, the first candidate value set comprises multiple numerical values.

In one embodiment, the first candidate value set comprises multiple binary values.

In one embodiment, the target candidate value subset comprises at least one value expressed in bits.

In one embodiment, the target candidate value subset comprises at least one numerical value.

In one embodiment, the target candidate value subset comprises at least one binary value.

In one embodiment, the second field comprises only 1 bit, and the first candidate value set comprises 0 and 1.

In one subembodiment, the target candidate value subset comprises only 0.

In one subembodiment, the target candidate value subset comprises only 1.

In one embodiment, the second field comprises only 2 bits, and the first candidate value set comprises 00, 01, 10 and 11.

In one subembodiment, the target candidate value subset comprises only one of 00, 01, 10 and 11.

In one subembodiment, the target candidate value subset comprises only two of 00, 01, 10 and 11.

In one subembodiment, the target candidate value subset comprises only three of 00, 01, 10 and 11.

In one embodiment, the second field comprises only 2 bits, and the first candidate value set comprises 1, 2, 3 and 4.

In one subembodiment, the target candidate value subset comprises only one of 1, 2, 3 and 4.

In one subembodiment, the target candidate value subset comprises only two of 1, 2, 3 and 4.

In one subembodiment, the target candidate value subset comprises only three of 1, 2, 3 and 4.

In one embodiment, when the first DCI does not include the second field: the MSB of the first field in the first DCI is used to indicate a frequency domain resource allocation type.

In one embodiment, in a configuration signaling received by the first node, a higher layer parameter resourceAllocation is configured as dynamicSwitch.

In one embodiment, in a configuration signaling received by the first node, a higher layer parameter resourceAllocationDCI-0-2 is configured as dynamicSwitch.

In one embodiment, in a configuration signaling received by the first node, a higher layer parameter resourceAllocationDCI-0-2-r16 is configured as dynamicSwitch.

In one embodiment, when the first DCI includes the second field and a value of the second field in the first DCI belongs to a target candidate value subset, the first field in the first DCI is used to indicate frequency domain resources in accordance with resource allocation type 0: when the first DCI includes the second field and the value of the second field in the first DCI does not belong to a target candidate value subset, the first field in the first DCI is used to indicate frequency domain resources in accordance with resource allocation type 1: a first candidate value set is a range of values of the second field, and the target candidate value subset is a non-empty proper subset of the first candidate value set.

In one embodiment, in a configuration signaling received by the first node, a higher layer parameter resourceAllocation is configured as resource Allocation Type0.

In one embodiment, in a configuration signaling received by the first node, a higher layer parameter resourceAllocationDCI-0-2 is configured as resourceAllocation Type0.

In one embodiment, in a configuration signaling received by the first node, a higher layer parameter resourceAllocationDCI-0-2-r16 is configured as resourceAllocation Type0.

In one embodiment, when the first DCI includes the second field and a value of the second field in the first DCI belongs to a target candidate value subset, the first field in the first DCI is used to indicate the MCS used by the first wireless channel from a first MCS index table: when the first DCI includes the second field and the value of the second field in the first DCI does not belong to a target candidate value subset, the first field in the first DCI is used to indicate the MCS used by the first wireless channel from a second MCS index table: a first candidate value set is a range of values of the second field, and the target candidate value subset is a non-empty proper subset of the first candidate value set, the first MCS index table is an MCS index table for PUSCHs with transform precoding enabled and the second MCS index table is an MCS index table at least for PUSCHs without transform precoding enabled.

In one embodiment, the first MCS index table is not used for PUSCHs without transform precoding enabled.

In one embodiment, in the first MCS index table, multiple MCS indexes respectively correspond to multiple MCS configurations; in the second MCS index table, multiple MCS indexes respectively correspond to multiple MCS configurations.

In one embodiment, the first MCS index table and the second MCS index table are two different MCS index tables as defined in 3GPP TS 38.214.

In one embodiment, the first MCS index table is an MCS index table as defined in Table 6.1.4.1-1 in 3GPP TS 38.214.

In one embodiment, the first MCS index table is an MCS index table as defined in Table 6.1.4.1-2 in 3GPP TS 38.214.

In one embodiment, the second MCS index table is an MCS index table as defined in Table 5.1.3.1-1 in 3GPP TS 38.214.

In one embodiment, the second MCS index table is an MCS index table as defined in Table 5.1.3.1-2 in 3GPP TS 38.214.

In one embodiment, the second MCS index table is an MCS index table as defined in Table 5.1.3.1-3 in 3GPP TS 38.214.

In one embodiment, when the first DCI does not include the second field: the waveform for the first wireless channel is configured by a higher layer signaling.

In one embodiment, when the first DCI does not include the second field: the waveform for the first wireless channel is configured by an RRC signaling.

In one embodiment, when the first DCI does not include the second field: the waveform for the first wireless channel is configured in an IE PUSCH-Config.

In one embodiment, when the first DCI does not include the second field: the waveform for the first wireless channel is configured by a parameter that includes transformPrecoder in its name.

In one embodiment, the first waveform is configurable.

In one embodiment, the first waveform is configured by a higher layer signaling.

In one embodiment, the first waveform is configured by an RRC signaling.

In one embodiment, the first waveform is configured by a MAC CE.

In one embodiment, the second waveform is configurable.

In one embodiment, the second waveform is configured by a higher layer signaling.

In one embodiment, the second waveform is configured by an RRC signaling.

In one embodiment, the second waveform is configured by a MAC CE.

In one embodiment, the second waveform is configured as one of a DFT-s-OFDM waveform and a CP-OFDM waveform, while the first waveform is the other of a DFT-s-OFDM waveform and a CP-OFDM waveform.

In one embodiment, the statement that “the first waveform and the second waveform are different physical layer waveforms, respectively” in the present application and “a candidate waveform set includes at least DFT-s-OFDM waveform and CP-OFDM waveform, the first waveform and the second waveform being two different waveforms in the candidate waveform set, respectively” are equivalent or interchangeable.

In one embodiment, a candidate waveform set includes multiple physical layer waveforms, the first waveform and the second waveform both belonging to the candidate waveform set.

In one embodiment, the candidate waveform set includes at least one of Discrete Fourier Transform-spread-OFDM (DFT-s-OFDM) waveform or Cyclic Prefix-OFDM (CP-OFDM) waveform.

In one embodiment, the candidate waveform set includes only DFT-s-OFDM waveform and CP-OFDM waveform.

In one embodiment, the candidate waveform set includes Filter Bank Multi Carrier (FBMC) waveform.

In one embodiment, the candidate waveform set includes Universal Filtered Multi-Carrier (UFMC) waveform.

In one embodiment, the candidate waveform set includes Filtered OFDM (F-OFDM) waveform.

In one embodiment, the statement that “the first waveform and the second waveform are different physical layer waveforms, respectively” in the present application and “the first waveform is one of a DFT-s-OFDM waveform or a CP-OFDM waveform, and the second waveform is one of a DFT-s-OFDM waveform or a CP-OFDM waveform, the second waveform being different from the first waveform” are equivalent or interchangeable.

In one embodiment, the first waveform is a DFT-s-OFDM waveform and the second waveform is a CP-OFDM waveform.

In one embodiment, the second waveform is a DFT-s-OFDM waveform and the first waveform is a CP-OFDM waveform.

In one embodiment, the DFT-s-OFDM waveform is: a waveform with Transform precoding being enabled.

In one embodiment, the CP-OFDM waveform is: a waveform with Transform precoding being not enabled.

In one embodiment, the CP-OFDM waveform is an OFDM waveform with a cyclic prefix.

In one embodiment, the first waveform is a waveform with Transform precoding being enabled and the second waveform is a waveform with Transform precoding being not enabled: or, the second waveform is a waveform with Transform precoding being enabled and the first waveform is a waveform with Transform precoding being not enabled.

### Embodiment 8

Embodiment 8 illustrates a schematic diagram of the relationship among first information, a first DCI, a first field group in the first DCI, a method of indication of the first field in the first DCI, and a waveform for the first wireless channel according to one embodiment of the present application, as shown in FIG. 8. In FIG. 8, in S81, determining whether the first field group in the first DCI is used to determine the waveform for the first wireless channel; in S82 the first field group in the first DCI is related to the method of indication of the first field in the first DCI; in S83 the first field group in the first DCI is independent of the method of indication of the first field in the first DCI.

In Embodiment 8, the first DCI comprises a first field group, the first field group comprising at least one field, and the first information is used to determine whether the first field group in the first DCI is used to determine the waveform for the first wireless channel; when the first field group in the first DCI is used to determine the waveform for the first wireless channel, the first field group in the first DCI is related to the method of indication of the first field in the first DCI; when the first field group in the first DCI is not used to determine the waveform for the first wireless channel, the first field group in the first DCI is independent of the method of indication of the first field in the first DCI.

In one embodiment, the first field group in the present application consists of at least one bit.

In one embodiment, the first field group in the present application consists of multiple bits.

In one embodiment, the first field group in the present application comprises only one field.

In one embodiment, the first field group in the present application comprises only 2 fields.

In one embodiment, the first field group in the present application comprises multiple fields.

In one embodiment, the first field group in the present application comprises a Frequency domain resource assignment field.

In one embodiment, the first field group in the present application comprises an SRS resource indicator field.

In one embodiment, the first field group in the present application comprises a field of Precoding information and number of layers.

In one embodiment, the first field group in the present application comprises a field of Antenna ports.

In one embodiment, a field in the first field group in the present application is used to indicate precoding information and a number of layers.

In one embodiment, a field in the first field group in the present application is used to indicate a Sounding reference signal (SRS) resource associated with a PUSCH transmission.

In one embodiment, a field in the first field group in the present application is used to indicate antenna ports.

In one embodiment, the first field group in the present application does not include the first field.

In one embodiment, the target bit group consists of all bits in the first field group.

In one embodiment, the target bit group consists of only part of bits in the first field group.

In one embodiment, the first information is used to indicate whether the first field group in the first DCI is used to determine the waveform for the first wireless channel.

In one embodiment, the first information explicitly indicates whether the first field group in the first DCI is used to determine the waveform for the first wireless channel.

In one embodiment, the first information implicitly indicates whether the first field group in the first DCI is used to determine the waveform for the first wireless channel.

In one embodiment, whether the first field group in the first DCI is used to determine the waveform for the first wireless channel is configured by the first information.

In one embodiment, there does not exist a field not belonging to the first field group being used to determine the waveform for the first wireless channel.

In one embodiment, the statement that “the first field group in the first DCI is used to determine the waveform for the first wireless channel” in the present application includes that each field of the first field group in the first DCI is used to determine the waveform for the first wireless channel.

In one embodiment, the statement that “the first field group in the first DCI is used to determine the waveform for the first wireless channel” in the present application includes that at least one bit of each field included in the first field group in the first DCI is used to determine the waveform for the first wireless channel.

In one embodiment, the statement that “the first field group in the first DCI is used to determine the waveform for the first wireless channel” in the present application includes that the first field group in the first DCI is used to indicate the waveform for the first wireless channel.

In one embodiment, the statement that “the first field group in the first DCI is used to determine the waveform for the first wireless channel” in the present application includes that the first field group in the first DCI is used to indicate whether the waveform for the first wireless channel is a DFT-s-OFDM waveform or a CP-OFDM waveform.

In one embodiment, the statement that “the first field group in the first DCI is used to determine the waveform for the first wireless channel” in the present application includes that the first field group in the first DCI implicitly indicates the waveform for the first wireless channel.

In one embodiment, the statement that “the first field group in the first DCI is used to determine the waveform for the first wireless channel” in the present application includes that the waveform for the first wireless channel is related to a value of at least one bit included in the first field group in the first DCI.

In one embodiment, the statement that “the first field group in the first DCI is used to determine the waveform for the first wireless channel” in the present application includes that the first field group in the first DCI is not only used to indicate the waveform for the first wireless channel but also used to indicate scheduling information other than the waveform for the first wireless channel.

In one embodiment, the statement that “the first field group in the first DCI is not used to determine the waveform for the first wireless channel” includes that the first field group in the first DCI is not used to indicate the waveform for the first wireless channel.

In one embodiment, the statement that “the first field group in the first DCI is not used to determine the waveform for the first wireless channel” includes that the waveform for the first wireless channel is configured by higher layer signaling.

In one embodiment, the statement that “the first field group in the first DCI is not used to determine the waveform for the first wireless channel” includes that the determination of the waveform for the first wireless channel is not dependent on any bit included in the first field group in the first DCI.

In one embodiment, the statement that “the first field group in the first DCI is not used to determine the waveform for the first wireless channel” includes that the first field group in the first DCI is only used to indicate scheduling information other than the waveform for the first wireless channel.

In one embodiment, the statement that “the first field group in the first DCI is related to the method of indication of the first field in the first DCI” in the present application comprises that the first field group in the first DCI is used to determine the method of indication of the first field in the first DCI.

In one embodiment, the statement that “the first field group in the first DCI is related to the method of indication of the first field in the first DCI” in the present application comprises that the determination of the method of indication of the first field in the first DCI is dependent on at least one bit included in the first field group in the first DCI.

In one embodiment, the statement that “the first field group in the first DCI is related to the method of indication of the first field in the first DCI” in the present application comprises that from which MCS index table the first field in the first DCI is used to indicate the MCS is dependent on at least one bit included in the first field group in the first DCI.

In one embodiment, the statement that “the first field group in the first DCI is related to the method of indication of the first field in the first DCI” in the present application comprises that whether the MSB of the first field in the first DCI is used to indicate a frequency domain resource allocation type is dependent on at least one bit included in the first field group in the first DCI.

In one embodiment, the statement that “the first field group in the first DCI is related to the method of indication of the first field in the first DCI” in the present application comprises that in accordance with which resource allocation type the first field in the first DCI is used to indicate frequency domain resources is dependent on at least one bit included in the first field group in the first DCI.

In one embodiment, the statement that “the first field group in the first DCI is independent of the method of indication of the first field in the first DCI” in the present application comprises that the first field group in the first DCI is not used to determine the method of indication of the first field in the first DCI.

In one embodiment, the statement that “the first field group in the first DCI is independent of the method of indication of the first field in the first DCI” in the present application comprises that the method of indication of the first field in the first DCI does not vary with a change in the value of any bit included in the first field group in the first DCI.

In one embodiment, the statement that “the first field group in the first DCI is independent of the method of indication of the first field in the first DCI” in the present application comprises: regardless of the value of the bit(s) included in the first field group in the first DCI, the MSB of the first field in the first DCI is always used to indicate a frequency domain resource allocation type.

In one embodiment, the statement that “the first field group in the first DCI is independent of the method of indication of the first field in the first DCI” in the present application comprises: regardless of the value of the bit(s) included in the first field group in the first DCI, the first field in the first DCI is always used to indicate frequency-domain resources in accordance with resource allocation type 0.

In one embodiment, the statement that “the first field group in the first DCI is independent of the method of indication of the first field in the first DCI” in the present application comprises: regardless of the value of the bit(s) included in the first field group in the first DCI, the first field in the first DCI is always used to indicate frequency-domain resources in accordance with resource allocation type 1.

In one embodiment, the statement that “the first field group in the first DCI is independent of the method of indication of the first field in the first DCI” in the present application comprises: regardless of the value of the bit(s) included in the first field group in the first DCI, the first field in the first DCI is always used to indicate the MCS from a same MCS index table.

In one embodiment, the statement that “the first field group in the first DCI is independent of the method of indication of the first field in the first DCI” in the present application comprises that the determination of the method of indication of the first field in the first DCI is not dependent on any bit included in the first field group in the first DCI.

In one embodiment, the statement that “the first field group in the first DCI is independent of the method of indication of the first field in the first DCI” in the present application comprises that from which MCS index table the first field in the first DCI is used to indicate the MCS is not dependent on any bit included in the first field group in the first DCI.

In one embodiment, the statement that “the first field group in the first DCI is independent of the method of indication of the first field in the first DCI” in the present application comprises that whether the MSB of the first field in the first DCI is used to indicate a frequency domain resource allocation type is not dependent on any bit included in the first field group in the first DCI.

In one embodiment, the statement that “the first field group in the first DCI is independent of the method of indication of the first field in the first DCI” in the present application comprises that in accordance with which resource allocation type the first field in the first DCI is used to indicate frequency domain resources is not dependent on any bit included in the first field group in the first DCI.

In one embodiment, when the first field group in the first DCI is not used to determine the waveform for the first wireless channel; the waveform for the first wireless channel is configured by higher layer signaling.

In one embodiment, when the first field group in the first DCI is not used to determine the waveform for the first wireless channel; the waveform for the first wireless channel is configured by RRC signaling. In one embodiment, when the first field group in the first DCI is not used to determine the waveform for the first wireless channel; the waveform for the first wireless channel is configured in an IE PUSCH-Config.

In one embodiment, when the first field group in the first DCI is not used to determine the waveform for the first wireless channel; the waveform for the first wireless channel is configured by a parameter that includes transformPrecoder in its name.

### Embodiment 9

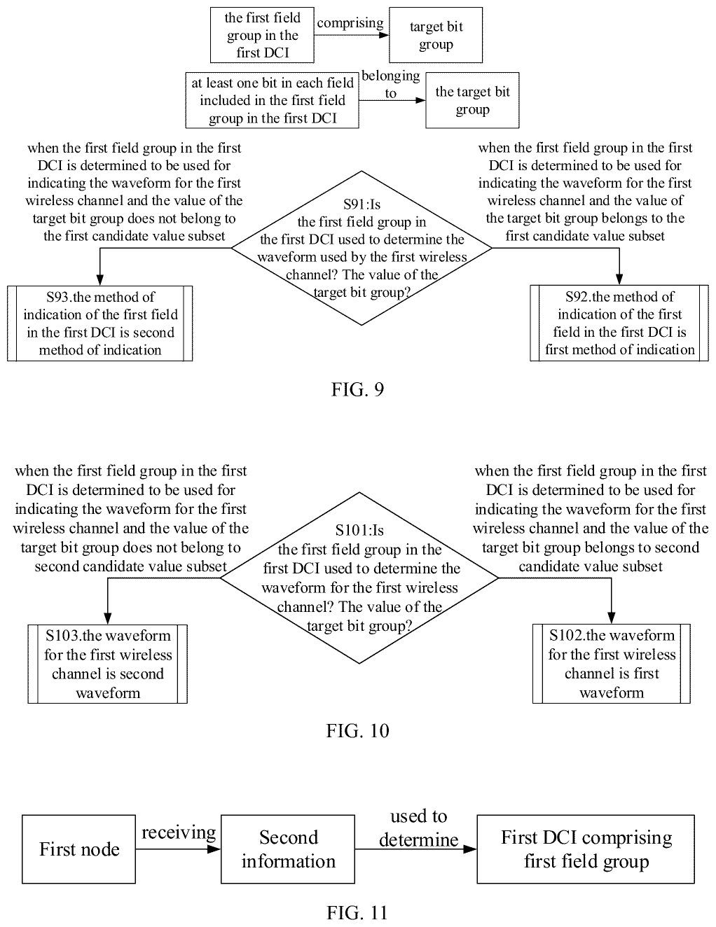

Embodiment 9 illustrates a schematic diagram of the relationship among a first field group in a first DCI, a target bit group and a method of indication of the first field in the first DCI according to one embodiment of the present application, as shown in FIG. 9. In FIG. 9, whether the first field group in the first DCI is used to determine the waveform for the first wireless channel and the value of the target bit group are determined in S91; in S92 the method of indication of the first field in the first DCI is a first method of indication; in S93 the method of indication of the first field in the first DCI is a second method of indication.

In Embodiment 9, the first field group in the first DCI comprises a target bit group, and at least one bit in each field included in the first field group in the first DCI belongs to the target bit group; when the first field group in the first DCI is determined to be used for indicating the waveform for the first wireless channel and a value of the target bit group belongs to a first candidate value subset, the method of indication of the first field in the first DCI is a first method of indication; when the first field group in the first DCI is determined to be used for indicating the waveform for the first wireless channel and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one embodiment, the MSB of the first field in the first DCI is used to indicate different frequency domain resource characteristics in the first method of indication and in the second method of indication, respectively.

In one embodiment, the first field in the first DCI is used to indicate frequency domain resources according to different resource allocation types in the first method of indication and in the second method of indication, respectively:

In one embodiment, the first field in the first DCI is used to indicate an MCS from different MCS index tables in the first method of indication and in the second method of indication, respectively.

In one embodiment, the statement “the method of indication of the first field in the first DCI is a first method of indication” in the present application comprises: an MSB of the first field in the first DCI being used to indicate a frequency domain resource allocation type.

In one embodiment, the statement “the method of indication of the first field in the first DCI is a second method of indication” in the present application comprises: an MSB of the first field in the first DCI not being used to indicate a frequency domain resource allocation type.

In one embodiment, the statement “the method of indication of the first field in the first DCI is a second method of indication” in the present application comprises: an MSB of the first field in the first DCI being used to indicate which resource blocks (RBs) are occupied by the first wireless channel.

In one embodiment, the statement “the method of indication of the first field in the first DCI is a second method of indication” in the present application comprises: at least one bit of the first field in the first DCI, including the MSB, being used to indicate which resource blocks (RBs) are occupied by the first wireless channel.

In one embodiment, the statement “the method of indication of the first field in the first DCI is a second method of indication” in the present application comprises: at least one bit of the first field in the first DCI, including the MSB, being used to indicate frequency domain resources occupied by the first wireless channel under the condition that resource allocation type 1 is used.

In one embodiment, the statement “the method of indication of the first field in the first DCI is a second method of indication” in the present application comprises: at least one bit of the first field in the first DCI, including the MSB, being used to indicate frequency domain resources occupied by the first wireless channel under the condition that resource allocation type 0 is used.

In one embodiment, the statement “the method of indication of the first field in the first DCI is a second method of indication” in the present application comprises: an MSB of the first field in the first DCI not being used to indicate information related to the frequency domain resources of the first wireless channel.

In one embodiment, the statement “the method of indication of the first field in the first DCI is a second method of indication” in the present application comprises: the value of an MSB of the first field in the first DCI being fixed and set to 0.

In one embodiment, the statement “the method of indication of the first field in the first DCI is a second method of indication” in the present application comprises: the value of an MSB of the first field in the first DCI being fixed and set to 1.

In one embodiment, the statement “the method of indication of the first field in the first DCI is a second method of indication” in the present application comprises: the first node does not support the value of the MSB of the first field in the first DCI being set to 0.

In one embodiment, the statement “the method of indication of the first field in the first DCI is a second method of indication” in the present application comprises: the first node does not support the value of the MSB of the first field in the first DCI being set to 1.

In one embodiment, the statement “the method of indication of the first field in the first DCI is a second method of indication” in the present application comprises: the first field in the first DCI being used to indicate frequency-domain resources in accordance with resource allocation type 0.

In one embodiment, the statement “the method of indication of the first field in the first DCI is a first method of indication” in the present application comprises: the first field in the first DCI being used to indicate frequency-domain resources in accordance with resource allocation type 1.

In one embodiment, the statement “the method of indication of the first field in the first DCI is a first method of indication” in the present application comprises: the first field in the first DCI being used to indicate, from a first MCS index table, the MCS used by the first wireless channel.

In one embodiment, the statement “the method of indication of the first field in the first DCI is a second method of indication” in the present application comprises: the first field in the first DCI being used to indicate, from a second MCS index table, the MCS used by the first wireless channel.

In one embodiment, the first MCS index table is an MCS index table for PUSCHs with transform precoding enabled, and the second MCS index table is an MCS index table at least for PUSCHs without transform precoding enabled.

In one embodiment, the first MCS index table is not used for PUSCHs without transform precoding enabled.

In one embodiment, in the first MCS index table, multiple MCS indexes respectively correspond to multiple MCS configurations; in the second MCS index table, multiple MCS indexes respectively correspond to multiple MCS configurations.

In one embodiment, the first MCS index table and the second MCS index table are two different MCS index tables as defined in 3GPP TS 38.214.

In one embodiment, the first MCS index table is an MCS index table as defined in Table 6.1.4.1-1 in 3GPP TS 38.214.

In one embodiment, the first MCS index table is an MCS index table as defined in Table 6.1.4.1-2 in 3GPP TS 38.214.

In one embodiment, the second MCS index table is an MCS index table as defined in Table 5.1.3.1-1 in 3GPP TS 38.214.

In one embodiment, the second MCS index table is an MCS index table as defined in Table 5.1.3.1-2 in 3GPP TS 38.214.

In one embodiment, the second MCS index table is an MCS index table as defined in Table 5.1.3.1-3 in 3GPP TS 38.214.

In one embodiment, when the first field group in the first DCI is determined to be used for indicating the waveform for the first wireless channel and the value of the target bit group belongs to the first candidate value subset, the waveform for the first wireless channel is a first waveform; when the first field group in the first DCI is determined to be used for indicating the waveform for the first wireless channel and the value of the target bit group does not belong to the first candidate value subset, the waveform for the first wireless channel is a second waveform; the first waveform and the second waveform are different physical layer waveforms, respectively.

In one embodiment, the first waveform is a DFT-s-OFDM waveform and the second waveform is a CP-OFDM waveform.

In one embodiment, the second waveform is a DFT-s-OFDM waveform and the first waveform is a CP-OFDM waveform.

In one embodiment, the first candidate value set is the range of values of the target bit group.

In one embodiment, the first candidate value set is a non-empty proper subset of the range of values of the target bit group.

In one embodiment, the first candidate value set is a set consisting of all valid values in the range of values of the target bit group.

In one embodiment, the first candidate value set comprises multiple candidate values.

In one embodiment, one candidate value in the first candidate value set is a value expressed in bits.

In one embodiment, one candidate value in the first candidate value set is a numerical value.

In one embodiment, one candidate value in the first candidate value set is a binary value.

In one embodiment, the first candidate value subset comprises at least one candidate value.

In one embodiment, one candidate value in the first candidate value subset is a value expressed in bits.

In one embodiment, one candidate value in the first candidate value subset is a numerical value.

In one embodiment, one candidate value in the first candidate value subset is a binary value.

In one embodiment, the target bit group consists of 1 bit, and the first candidate value set comprises 0 and 1.

In one subembodiment, the first candidate value subset comprises only 0.

In one subembodiment, the first candidate value subset comprises only 1.

In one embodiment, the target bit group consists of 2 bits, and the first candidate value set comprises at least two of 00, 01, 10 and 11.

In one subembodiment, the first candidate value subset comprises only one of 00, 01, 10 and 11.

In one subembodiment, the first candidate value subset comprises only two of 00, 01, 10 and 11.

In one subembodiment, the first candidate value subset comprises only three of 00, 01, 10 and 11.

In one embodiment, the target bit group consists of 2 bits, and the first candidate value set comprises at least two of 1, 2, 3 and 4.

In one subembodiment, the first candidate value subset comprises only one of 1, 2, 3 and 4.

In one subembodiment, the first candidate value subset comprises only two of 1, 2, 3 and 4.

In one subembodiment, the first candidate value subset comprises only three of 1, 2, 3 and 4.

In one embodiment, the target bit group consists of 3 bits, and the first candidate value set comprises at least two of 000, 001, 010, 011, 100, 101, 110 and 111.

In one embodiment, the target bit group consists of 4 bits, and the first candidate value set comprises at least two of 0000, 0001, 0010, 0011, 0100, 0101, 0110, 0111, 1000, 1001, 1010, 1011, 1100, 1101, 1110 and 1111.

In one embodiment, the target bit group consists of at most 1024 bits.

In one embodiment, the value of the target bit group is a value expressed in bits in the target bit group.

In one embodiment, the value of the target bit group is a binary value expressed in bits in the target bit group.

In one embodiment, the value of the target bit group is a numerical value expressed in bits in the target bit group.

In one embodiment, the value of the target bit group is a value jointly represented by all bits in the target bit group.

In one embodiment, the value of the target bit group is a binary value jointly represented by all bits in the target bit group.

In one embodiment, the value of the target bit group is a numerical value jointly represented by all bits in the target bit group.

In one embodiment, when the value of the target bit group belongs to the first candidate value subset, a number of transmission layer(s) for signal transmitting on the first wireless channel is not greater than M; when the value of the target bit group does not belong to the first candidate value subset, the number of transmission layer(s) for signal transmitting on the first wireless channel is greater than M; M is a positive integer.

In one embodiment, when the value of the target bit group belongs to the first candidate value subset, a number of transmission layer(s) for signal transmitting on the first wireless channel is greater than M; when the value of the target bit group does not belong to the first candidate value subset, the number of transmission layer(s) for signal transmitting on the first wireless channel is not greater than M; M is a positive integer.

In one embodiment, when the value of the target bit group belongs to the first candidate value subset, a number of transmission layer(s) for signal transmitting on the first wireless channel is equal to M; when the value of the target bit group does not belong to the first candidate value subset, the number of transmission layer(s) for signal transmitting on the first wireless channel is not equal to M; M is a positive integer.

In one embodiment, when the value of the target bit group belongs to the first candidate value subset, a number of transmission layer(s) for signal transmitting on the first wireless channel is not equal to M; when the value of the target bit group does not belong to the first candidate value subset, the number of transmission layer(s) for signal transmitting on the first wireless channel is equal to M; M is a positive integer.

In one embodiment, when the value of the target bit group belongs to the first candidate value subset, a number of transmission layer(s) for signal transmitting on the first wireless channel is less than M; when the value of the target bit group does not belong to the first candidate value subset, the number of transmission layer(s) for signal transmitting on the first wireless channel is no less than M; M is a positive integer.

In one embodiment, when the value of the target bit group belongs to the first candidate value subset, a number of transmission layer(s) for signal transmitting on the first wireless channel is no less than M; when the value of the target bit group does not belong to the first candidate value subset, the number of transmission layer(s) for signal transmitting on the first wireless channel is less than M; M is a positive integer.

In one embodiment, M is equal to 1.

In one embodiment, M is equal to 2.

In one embodiment, M is no greater than 8.

In one embodiment, M is no greater than 1024.

In one embodiment, M is configurable.

In one embodiment, M is predefined.

### Embodiment 10

Embodiment 10 illustrates a schematic diagram of the relationship among a first field group in a first DCI, a target bit group and a waveform for the first wireless channel according to one embodiment of the present application, as shown in FIG. 10. In FIG. 10, whether the first field group in the first DCI is used to determine the waveform for the first wireless channel and the value of the target bit group are determined in S101; in S102, the waveform for the first wireless channel is a first waveform; in S103, the waveform for the first wireless channel is a second waveform.

In Embodiment 10, when the first field group in the first DCI is determined to be used for indicating the waveform for the first wireless channel and the value of the target bit group belongs to a second candidate value subset, the waveform for the first wireless channel is a first waveform; when the first field group in the first DCI is determined to be used for indicating the waveform for the first wireless channel and the value of the target bit group does not belong to the second candidate value subset, the waveform for the first wireless channel is a second waveform; the first waveform and the second waveform are different physical layer waveforms, respectively; the second candidate value subset being a non-empty proper subset of the first candidate value set; the second candidate value subset is a non-empty proper subset of the first candidate value subset, or the first candidate value subset is a non-empty proper subset of the second candidate value subset.

In one embodiment, the second candidate value subset comprises at least one candidate value.

In one embodiment, one candidate value in the second candidate value subset is a value expressed in bits.

In one embodiment, one candidate value in the second candidate value subset is a numerical value.

In one embodiment, one candidate value in the second candidate value subset is a binary value.

In one embodiment, the first waveform is a DFT-s-OFDM waveform and the second waveform is a CP-OFDM waveform.

In one embodiment, the second waveform is a DFT-s-OFDM waveform and the first waveform is a CP-OFDM waveform.

### Embodiment 11

Embodiment 11 illustrates a schematic diagram of the relationship among a first node, second information as well as a first DCI comprising a first field group according to one embodiment of the present application, as shown in FIG. 11.

In Embodiment 11, the first node in this application receives second information, the second information being used to determine that the first DCI comprises the first field group.

In one embodiment, the first node firstly receives the first information and then receives the second information.

In one embodiment, the first node firstly receives the second information and then receives the first information.

In one embodiment, the first node receives the first information and the second information simultaneously.

In one embodiment, the first node firstly receives the second information and then receives the first DCI.

In one embodiment, the first node receives second information, the second information indicating the presence of the first field group in the first DCI.

In one embodiment, the first node receives second information, the second information explicitly indicating that the first DCI includes the first field group.

In one embodiment, the first node receives second information, the second information implicitly indicating that the first DCI includes the first field group.

In one embodiment, the first node receives second information; based on configuration of the second information, the first DCI includes the first field group.

In one embodiment, the second information is a physical layer signaling.

In one embodiment, the second information is a Downlink control information (DCI) format.

In one embodiment, the second information is a DCI other than the first DCI.

In one embodiment, the second information does not belong to the first DCI.

In one embodiment, the second information is DCI format 0_0, for the specific definition of the DCI format 0_0, refer to Section 7.3.1.1 of 3GPP TS 38.212.

In one embodiment, the second information is DCI format 0_1, for the specific definition of the DCI format 0_1, refer to Section 7.3.1.1 of 3GPP TS 38.212.

In one embodiment, the second information is DCI format 0_2, for the specific definition of the DCI format 0_2, refer to Section 7.3.1.1 of 3GPP TS 38.212.

In one embodiment, the second information is DCI format 1_0, for the specific definition of the DCI format 1_0, refer to Section 7.3.1.2 of 3GPP TS 38.212.

In one embodiment, the second information is DCI format 1_1, for the specific definition of the DCI format 1_1, refer to Section 7.3.1.2 of 3GPP TS 38.212.

In one embodiment, the second information is DCI format 1_2, for the specific definition of the DCI format 1_2, refer to Section 7.3.1.2 of 3GPP TS 38.212.

In one embodiment, the second information comprises one or more fields in a DCI format.

In one embodiment, the second information is a higher layer signaling.

In one embodiment, the second information is an RRC signaling.

In one embodiment, the second information comprises one or more fields in an RRC signaling.

In one embodiment, the second information comprises one Information Element (IE).

In one embodiment, the second information comprises one or more fields in an IE.

In one embodiment, the second information is a Medium Access Control layer Control Element (MAC CE).

In one embodiment, the second information comprises one or more fields in a MAC CE.

In one embodiment, the second information belongs to an IE PUSCH-Config.

In one embodiment, the second information comprises an IE PUSCH-Config.

In one embodiment, the second information is an IE PUSCH-Config.

### Embodiment 12

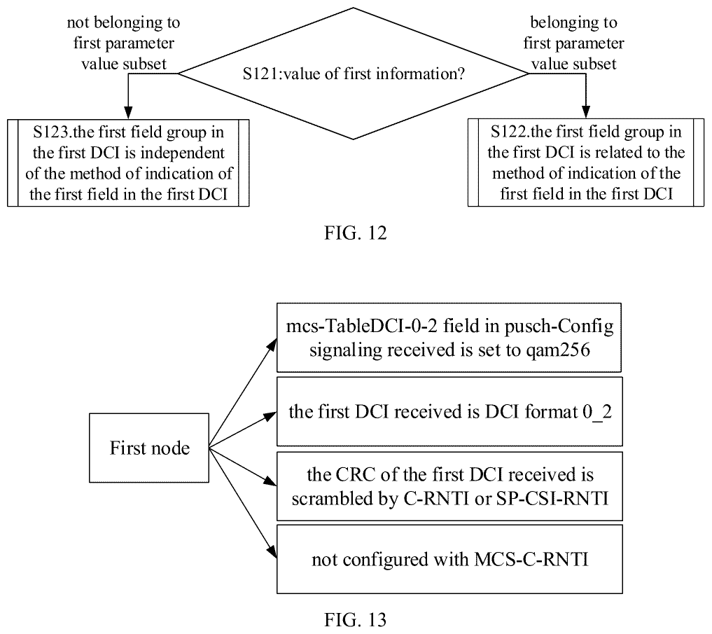

Embodiment 12 illustrates a schematic diagram of the relationship among first information, a first field group in a first DCI, and a method of indication of the first field in the first DCI according to one embodiment of the present application, as shown in FIG. 12. In FIG. 12, the value of the first information is determined in S121; in S122, the first field group in the first DCI is related to the method of indication of the first field in the first DCI; and in S123, the first field group in the first DCI is independent of the method of indication of the first field in the first DCI.

In Embodiment 12, the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information belongs to the first parameter value subset, the first field group in the first DCI is related to the method of indication of the first field in the first DCI; when the value of the first information does not belong to the first parameter value subset, the first field group in the first DCI is independent of the method of indication of the first field in the first DCI.

In one embodiment, the statement that “the first field group in the first DCI is independent of the method of indication of the first field in the first DCI” in the present application comprises: the meaning indicated by each bit included in the first field group in the first DCI is determined based on the configuration of higher layer signaling or is predefined.

In one embodiment, the statement that “the first field group in the first DCI is independent of the method of indication of the first field in the first DCI” in the present application comprises: regardless of the value of the bit(s) included in the first field group in the first DCI, the first field in the first DCI is always used to indicate, from a second MCS index table, the MCS used by the first wireless channel.

In one embodiment, the statement that “the first field group in the first DCI is independent of the method of indication of the first field in the first DCI” in the present application comprises: the first field in the first DCI is always used to indicate, from a second MCS index table, the MCS used by the first wireless channel.

In one embodiment, the statement that “the first field group in the first DCI is independent of the method of indication of the first field in the first DCI” in the present application comprises: an MCS index table on which an indication of the MCS from the first field in the first DCI is based being not dependent on the first field group in the first DCI.

In one embodiment, the second MCS index table is an MCS index table at least for PUSCHs without transform precoding enabled.

In one embodiment, the second MCS index table is an MCS index table as defined in Table 5.1.3.1-1 in 3GPP TS 38.214.

In one embodiment, the second MCS index table is an MCS index table as defined in Table 5.1.3.1-2 in 3GPP TS 38.214.

In one embodiment, the second MCS index table is an MCS index table as defined in Table 5.1.3.1-3 in 3GPP TS 38.214.

In one embodiment, parameter values in the first parameter value set are all parameter values that are candidates for a higher layer parameter.

In one embodiment, parameter values in the first parameter value set are all parameter values that are candidates for an RRC layer parameter.

In one embodiment, parameter values in the first parameter value set are all parameter values that are candidates for a MAC layer parameter.

In one embodiment, parameter values in the first parameter value set are all parameter values that are candidates for the first information.

In one embodiment, the first information is a resourceAllocation parameter.

In one embodiment, the first information is a resourceAllocation field.

In one embodiment, the first information is a resourceAllocationDCI-0-2-r16 parameter.

In one embodiment, the first information is a resourceAllocationDCI-0-2-r16 field.

In one embodiment, a name of the first information includes resourceAllocation.

In one embodiment, the value of the first information is configured.

In one embodiment, the first parameter value set includes multiple different parameter values.

In one embodiment, the first parameter value set includes {resourceAllocationType0, resourceAllocationType1, dynamicSwitch}.

In one embodiment, the value of the first information is one of {resourceAllocation Type0, resourceAllocationType1, dynamicSwitch}.

In one embodiment, the first parameter value subset includes only dynamicSwitch.

In one embodiment, the first parameter value subset includes only resourceAllocation Type0.

In one embodiment, the first parameter value subset includes only resourceAllocationType1.

In one embodiment, the first parameter value subset includes dynamicSwitch and resourceAllocation Type0.

In one embodiment, the first parameter value subset comprises only one parameter value in the first parameter value set.

In one embodiment, the first parameter value subset comprises 2 parameter values in the first parameter value set.

In one embodiment, the first node is not configured with a MCS-C-RNTI.

In one embodiment, the first node is configured with a MCS-C-RNTI.

In one embodiment, the first parameter value set comprises {qam256, qam64LowSE}.

In one embodiment, the first parameter value subset includes only qam64LowSE.

In one embodiment, the first parameter value subset includes only qam256.

In one embodiment, the value of the first information is one of {qam256, qam64LowSE}.

In one embodiment, the name of the first information includes mes-TableTransformPrecoder.

In one embodiment, the first information is a field in an information element (IE) PUSCH-Config.

In one embodiment, the first information is a parameter mes-Table TransformPrecoder.

In one embodiment, the first information is a field of mcs-Table TransformPrecoder.

In one embodiment, the first information is a field of mes-TableTransformPrecoderDCI-0-2 in pusch-Config signaling.

In one embodiment, the first information is a parameter mcs-TableTransformPrecoderDCI-0-2 in pusch-Config signaling.

In one embodiment, a mcs-TableDCI-0-2 field in the pusch-Config signaling received by the first node is set to qam256.

In one embodiment, the first DCI is DCI format 0_2 and a CRC of the first DCI is scrambled by a C-RNTI or SP-CSI-RNTI.

In one embodiment, the first DCI is received in a PDCCH.

### Embodiment 13

Embodiment 13 illustrates a schematic diagram explaining a first node and associated configurations of a first DCI according to one embodiment of the present application, as shown in FIG. 13.

In Embodiment 13, a mcs-TableDCI-0-2 field in a pusch-Config signaling received by the first node in this application is set to qam256, the first DCI is DCI format 0_2, the CRC of the first DCI is scrambled by C-RNTI or SP-CSI-RNTI, and the first node is not configured with MCS-C-RNTI.

In one subembodiment of Embodiment 13, the first information in this application is mcs-Table TransformPrecoderDCI-0-2 in the pusch-Config signaling.

### Embodiment 14

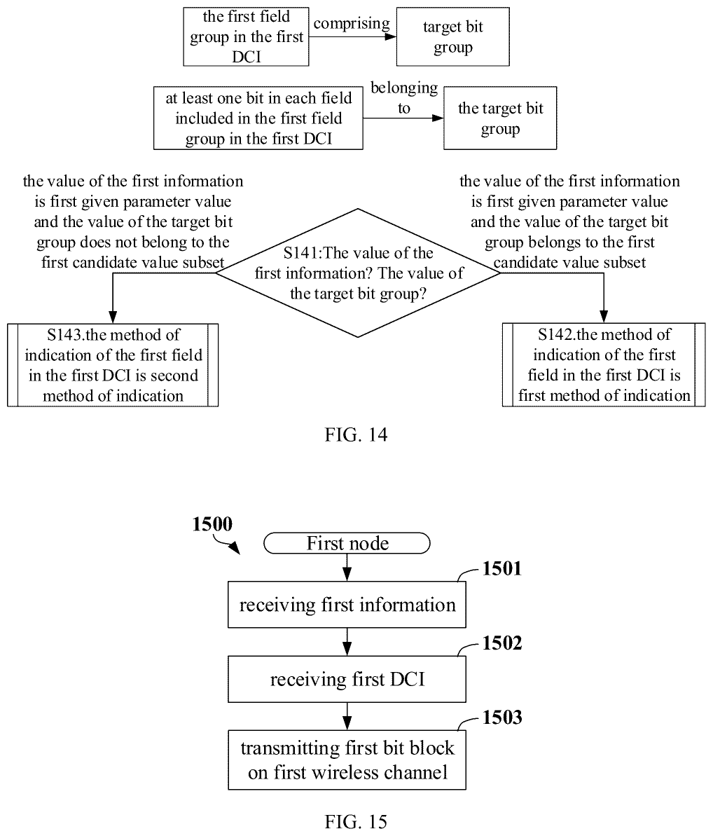

Embodiment 14 illustrates a schematic diagram of the relationship among first information, a first field group in a first DCI, a target bit group and a method of indication of the first field in the first DCI according to one embodiment of the present application, as shown in FIG. 14. In FIG. 14, the value of the first information and the value of the target bit group are determined in S141; in S142 the method of indication of the first field in the first DCI is a first method of indication; in S143 the method of indication of the first field in the first DCI is a second method of indication.

In Embodiment 14, the first field group in the first DCI comprises a target bit group, and at least one bit in each field included in the first field group in the first DCI belongs to the target bit group; a first given parameter value is one parameter value in the first parameter value subset; when the value of the first information is the first given parameter value and a value of the target bit group belongs to a first candidate value subset, the method of indication of the first field in the first DCI is a first method of indication; when the value of the first information is the first given parameter value and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one embodiment, when the value of the first information is the first given parameter value and the value of the target bit group belongs to the first candidate value subset, the waveform for the first wireless channel is a first waveform; when the value of the first information is the first given parameter value and the value of the target bit group does not belong to the first candidate value subset, the waveform for the first wireless channel is a second waveform; the first waveform and the second waveform are different physical layer waveforms, respectively.

In one embodiment, a second given parameter value is one parameter value in the first parameter value subset; when the value of the first information is the second given parameter value and the value of the target bit group belongs to a second candidate value subset, the method of indication of the first field in the first DCI is a third method of indication; when the value of the first information is the second given parameter value and the value of the target bit group does not belong to the second candidate value subset, the method of indication of the first field in the first DCI is a fourth method of indication; the second candidate value subset is a non-empty proper subset of the first candidate value set, the third method of indication being different from the fourth method of indication.

In one embodiment, when the value of the first information is the second given parameter value and the value of the target bit group belongs to the second candidate value subset, the waveform for the first wireless channel is a first waveform; when the value of the first information is the second given parameter value and the value of the target bit group does not belong to the second candidate value subset, the waveform for the first wireless channel is a second waveform; the first waveform and the second waveform are different physical layer waveforms, respectively.

In one embodiment, the first candidate value set comprises multiple candidate values that are mutually different.

In one embodiment, one candidate value in the first candidate value set is a value expressed in bits.

In one embodiment, one candidate value in the first candidate value set is a numerical value.

In one embodiment, one candidate value in the first candidate value set is a binary value.

In one embodiment, the first candidate value subset comprises at least one candidate value.

In one embodiment, one candidate value in the first candidate value subset is a value expressed in bits.

In one embodiment, one candidate value in the first candidate value subset is a numerical value.

In one embodiment, one candidate value in the first candidate value subset is a binary value.

In one embodiment, the second candidate value subset is the first candidate value subset.

In one embodiment, the second candidate value subset is a non-empty proper subset of the first candidate value subset.

In one embodiment, the first candidate value subset is a non-empty proper subset of the second candidate value subset.

In one embodiment, the first candidate value subset and the second candidate value subset are mutually orthogonal.

In one embodiment, there does not exist any candidate value in the first candidate value set that belongs to both the first candidate value subset and the second candidate value subset.

In one embodiment, any candidate value in the first candidate value set belongs to one of the first candidate value subset or the second candidate value subset, and there does not exist any candidate value in the first candidate value set that belongs to both the first candidate value subset and the second candidate value subset.

In one embodiment, there exists at least one candidate value in the first candidate value set that belongs to the second candidate value subset and does not belong to the first candidate value subset.

In one embodiment, there exists at least one candidate value in the first candidate value set that belongs to the first candidate value subset and does not belong to the second candidate value subset.

In one embodiment, the third method of indication is the first method of indication and the fourth method of indication is the second method of indication.

In one embodiment, the third method of indication is the first method of indication and the fourth method of indication is different from the second method of indication.

In one embodiment, the third method of indication is different from the first method of indication and the fourth method of indication is the second method of indication.

In one embodiment, the third method of indication is different from the first method of indication and the fourth method of indication is different from the second method of indication.

In one embodiment, the third method of indication is the second method of indication and the fourth method of indication is the first method of indication.

In one embodiment, the third method of indication is the second method of indication and the fourth method of indication is different from the first method of indication.

In one embodiment, the third method of indication is different from the second method of indication and the fourth method of indication is the first method of indication.

In one embodiment, the third method of indication is different from the second method of indication and the fourth method of indication is different from the first method of indication.

In one embodiment, the MSB of the first field in the first DCI is used to indicate different frequency domain resource characteristics in the first method of indication and in the second method of indication, respectively.

In one embodiment, the first field in the first DCI is used to indicate frequency domain resources according to different resource allocation types in the first method of indication and in the second method of indication, respectively.

In one embodiment, the first field in the first DCI is used to indicate an MCS from different MCS index tables in the first method of indication and in the second method of indication, respectively.

In one embodiment, the MSB of the first field in the first DCI is used to indicate different frequency domain resource characteristics in the third method of indication and in the fourth method of indication, respectively.

In one embodiment, the first field in the first DCI is used to indicate frequency domain resources according to different resource allocation types in the third method of indication and in the fourth method of indication, respectively.

In one embodiment, the first field in the first DCI is used to indicate an MCS from different MCS index tables in the third method of indication and in the fourth method of indication, respectively.

In one embodiment, the statement “the method of indication of the first field in the first DCI is a third method of indication” in the present application comprises: an MSB of the first field in the first DCI being used to indicate a frequency domain resource allocation type.

In one embodiment, the statement “the method of indication of the first field in the first DCI is a fourth method of indication” in the present application comprises: an MSB of the first field in the first DCI not being used to indicate a frequency domain resource allocation type.

In one embodiment, the statement “the method of indication of the first field in the first DCI is a fourth method of indication” in the present application comprises: an MSB of the first field in the first DCI being used to indicate which resource blocks (RBs) are occupied by the first wireless channel.

In one embodiment, the statement “the method of indication of the first field in the first DCI is a fourth method of indication” in the present application comprises: at least one bit of the first field in the first DCI, including the MSB, being used to indicate which resource blocks (RBs) are occupied by the first wireless channel.

In one embodiment, the statement “the method of indication of the first field in the first DCI is a fourth method of indication” in the present application comprises: at least one bit of the first field in the first DCI, including the MSB, being used to indicate frequency domain resources occupied by the first wireless channel under the condition that resource allocation type 1 is used.

In one embodiment, the statement “the method of indication of the first field in the first DCI is a fourth method of indication” in the present application comprises: at least one bit of the first field in the first DCI, including the MSB, being used to indicate frequency domain resources occupied by the first wireless channel under the condition that resource allocation type 0 is used.

In one embodiment, the statement “the method of indication of the first field in the first DCI is a fourth method of indication” in the present application comprises: an MSB of the first field in the first DCI not being used to indicate information related to the frequency domain resources of the first wireless channel.

In one embodiment, the statement “the method of indication of the first field in the first DCI is a fourth method of indication” in the present application comprises: the value of an MSB of the first field in the first DCI being fixed and set to 0.

In one embodiment, the statement “the method of indication of the first field in the first DCI is a fourth method of indication” in the present application comprises: the value of an MSB of the first field in the first DCI being fixed and set to 1.

In one embodiment, the statement “the method of indication of the first field in the first DCI is a fourth method of indication” in the present application comprises: the first node does not support the value of the MSB of the first field in the first DCI being set to 0.

In one embodiment, the statement “the method of indication of the first field in the first DCI is a fourth method of indication” in the present application comprises: the first node does not support the value of the MSB of the first field in the first DCI being set to 1.

In one embodiment, the statement “the method of indication of the first field in the first DCI is a fourth method of indication” in the present application comprises: the first field in the first DCI being used to indicate frequency-domain resources in accordance with resource allocation type 0.

In one embodiment, the statement “the method of indication of the first field in the first DCI is a third method of indication” in the present application comprises: the first field in the first DCI being used to indicate frequency-domain resources in accordance with resource allocation type 1.

In one embodiment, the statement “the method of indication of the first field in the first DCI is a third method of indication” in the present application comprises: the first field in the first DCI being used to indicate, from a first MCS index table, the MCS used by the first wireless channel.

In one embodiment, the statement “the method of indication of the first field in the first DCI is a fourth method of indication” in the present application comprises: the first field in the first DCI being used to indicate, from a second MCS index table, the MCS used by the first wireless channel.

In one embodiment, the first MCS index table is an MCS index table for PUSCHs with transform precoding enabled, and the second MCS index table is an MCS index table at least for PUSCHs without transform precoding enabled.

In one embodiment, the first MCS index table is not used for PUSCHs without transform precoding enabled.

In one embodiment, in the first MCS index table, multiple MCS indexes respectively correspond to multiple MCS configurations; in the second MCS index table, multiple MCS indexes respectively correspond to multiple MCS configurations.

In one embodiment, the first MCS index table and the second MCS index table are two different MCS index tables as defined in 3GPP TS 38.214.

In one embodiment, the first MCS index table is an MCS index table as defined in Table 6.1.4.1-1 in 3GPP TS 38.214.

In one embodiment, the first MCS index table is an MCS index table as defined in Table 6.1.4.1-2 in 3GPP TS 38.214.

In one embodiment, the second MCS index table is an MCS index table as defined in Table 5.1.3.1-1 in 3GPP TS 38.214.

In one embodiment, the second MCS index table is an MCS index table as defined in Table 5.1.3.1-2 in 3GPP TS 38.214.

In one embodiment, the second MCS index table is an MCS index table as defined in Table 5.1.3.1-3 in 3GPP TS 38.214.

In one embodiment, the target bit group comprises a Least Significant Bit (LSB) of at least one field of the first field group.

In one embodiment, the target bit group comprises a Most Significant Bit (MSB) of at least one field of the first field group.

In one embodiment, the first parameter value subset comprises only the first given parameter value.

In one embodiment, the first given parameter value is resourceAllocation Type0.

In one embodiment, the first given parameter value is resourceAllocationType1.

In one embodiment, the first given parameter value is dynamicSwitch.

In one embodiment, a name of the first given parameter value includes resourceAllocation Type0.

In one embodiment, a name of the first given parameter value includes resourceAllocationType1.

In one embodiment, a name of the first given parameter value includes dynamicSwitch.

In one embodiment, the first given parameter value is any parameter value in the first parameter value subset.

In one embodiment, the second given parameter value is any parameter value in the first parameter value subset.

In one embodiment, the first given parameter value is one parameter value in the first parameter value subset, and the second given parameter value is any parameter value in the first parameter value subset other than the first given parameter value.

In one embodiment, the second given parameter value is one parameter value in the first parameter value subset, and the first given parameter value is any parameter value in the first parameter value subset other than the second given parameter value.

In one embodiment, the first given parameter value and the second given parameter value are two different parameter values in the first parameter value subset.

In one embodiment, the first parameter value subset comprises only the first given parameter value and the second given parameter value.

In one embodiment, the second given parameter value is resourceAllocationType0.

In one embodiment, the second given parameter value is resourceAllocationType1.

In one embodiment, the second given parameter value is dynamicSwitch.

In one embodiment, a name of the second given parameter value includes resourceAllocation Type0.

In one embodiment, a name of the second given parameter value includes resourceAllocationType1.

In one embodiment, a name of the second given parameter value includes dynamicSwitch.

In one embodiment, the first given parameter value and the second given parameter value are dynamicSwitch and resourceAllocation Type0, respectively.

In one embodiment, the first given parameter value and the second given parameter value are two of resourceAllocation Type0, resourceAllocationType1 and dynamicSwitch, respectively.

In one embodiment, the first given parameter value is used to denote a resource allocation type or is used to denote that a DCI is used to indicate a resource allocation type.

In one embodiment, the second given parameter value is used to denote a resource allocation type or is used to denote that a DCI is used to indicate a resource allocation type.

In one embodiment, the first given parameter value is qam64LowSE.

In one embodiment, the first given parameter value is qam256.

In one embodiment, a name of the first given parameter value includes qam64LowSE.

In one embodiment, a name of the first given parameter value includes qam256.

In one embodiment, the first candidate value set comprises multiple candidate values.

In one embodiment, one candidate value in the first candidate value set is a value expressed in bits.

In one embodiment, one candidate value in the first candidate value set is a numerical value.

In one embodiment, one candidate value in the first candidate value set is a binary value.

In one embodiment, the first candidate value subset comprises at least one candidate value.

In one embodiment, one candidate value in the first candidate value subset is a value expressed in bits.

In one embodiment, one candidate value in the first candidate value subset is a numerical value.

In one embodiment, one candidate value in the first candidate value subset is a binary value.

In one embodiment, the second candidate value subset comprises at least one candidate value.

In one embodiment, one candidate value in the second candidate value subset is a value expressed in bits.

In one embodiment, one candidate value in the second candidate value subset is a numerical value.

In one embodiment, one candidate value in the second candidate value subset is a binary value.

In one embodiment, the target bit group consists of 1 bit, and the first candidate value set comprises 0 and 1.

In one subembodiment, the first candidate value subset comprises only 0.

In one subembodiment, the first candidate value subset comprises only 1.

In one subembodiment, the first candidate value subset comprises only 0 and the second candidate value subset comprises only 1.

In one subembodiment, the first candidate value subset comprises only 1 and the second candidate value subset comprises only 0.

In one embodiment, the target bit group consists of 2 bits, and the first candidate value set comprises at least two of 00, 01, 10 and 11.

In one subembodiment, the first candidate value subset comprises only one of 00, 01, 10 and 11.

In one subembodiment, the first candidate value subset comprises only two of 00, 01, 10 and 11.

In one subembodiment, the first candidate value subset comprises only three of 00, 01, 10 and 11.

In one subembodiment, the second candidate value subset comprises only one of 00, 01, 10 and 11.

In one subembodiment, the second candidate value subset comprises only two of 00, 01, 10 and 11.

In one subembodiment, the second candidate value subset comprises only three of 00, 01, 10 and 11.

In one embodiment, the target bit group consists of 2 bits, and the first candidate value set comprises at least two of 1, 2, 3 and 4.

In one subembodiment, the first candidate value subset comprises only one of 1, 2, 3 and 4.

In one subembodiment, the first candidate value subset comprises only two of 1, 2, 3 and 4.

In one subembodiment, the first candidate value subset comprises only three of 1, 2, 3 and 4.

In one subembodiment, the second candidate value subset comprises only one of 1, 2, 3 and 4.

In one subembodiment, the second candidate value subset comprises only two of 1, 2, 3 and 4.

In one subembodiment, the second candidate value subset comprises only three of 1, 2, 3 and 4.

In one embodiment, the target bit group consists of 3 bits, and the first candidate value set comprises at least two of 000, 001, 010, 011, 100, 101, 110 and 111.

In one embodiment, the target bit group consists of 4 bits, and the first candidate value set comprises at least two of 0000, 0001, 0010, 0011, 0100, 0101, 0110, 0111, 1000, 1001, 1010, 1011, 1100, 1101, 1110 and 1111.

In one embodiment, the target bit group consists of at most 1024 bits.

### Embodiment 15

Embodiment 15 illustrates a flowchart of processing of a first node according to one embodiment of the present application, as shown in FIG. 15.

In Embodiment 15, the first node in the present application receives first information in step 1501; receives a first DCI in step 1502; and transmits a first bit block on a first wireless channel in step 1503.

In Embodiment 15, the first DCI is used to schedule the first wireless channel; the first information is used to determine a resource allocation type used for the first wireless channel; whether the first node supports the presence of a field in the first DCI being used to determine the waveform for the first wireless channel is related to a value of the first information: when the value of the first information denotes using resource allocation type 0: the first node does not support the presence of the field in the first DCI being used to determine the waveform for the first wireless channel.

In one embodiment, the first DCI is DCI format 0_1.

In one embodiment, the first DCI is DCI format 0_2.

In one embodiment, the first DCI uses DCI format 0_1.

In one embodiment, the first DCI uses DCI format 0_2.

In one embodiment, the DCI of the first type is a DCI in a specific DCI format.

In one embodiment, the DCI of the first type is a DCI in DCI format 0_1.

In one embodiment, the DCI of the first type is a DCI in DCI format 0_2.

In one embodiment, when the value of the first information denotes using resource allocation type 1: the first node supports the presence of the field in the first DCI being used to determine the waveform for the first wireless channel.

In one embodiment, when the value of the first information denotes a first field being used to indicate a resource allocation type: the first node supports the presence of the field in the first DCI being used to determine the waveform for the first wireless channel.

In one embodiment, when the value of the first information denotes a first field being used to indicate a resource allocation type: the first node does not support the presence of the field in the first DCI being used to determine the waveform for the first wireless channel.

In one embodiment, when the value of the first information denotes using resource allocation type 1: the first node supports the presence of the field in the DCIs of the first type being used to determine the waveform for the first wireless channel.

In one embodiment, when the value of the first information denotes a first field being used to indicate a resource allocation type: the first node supports the presence of the field in the DCIs of the first type being used to determine the waveform for the first wireless channel.

In one embodiment, when the value of the first information denotes a first field being used to indicate a resource allocation type: the first node does not support the presence of the field in the DCIs of the first type being used to determine the waveform for the first wireless channel.

In one embodiment, the first field is a field in a DCI.

In one embodiment, the first field consists of at least one bit.

In one embodiment, the first field comprises multiple bits.

In one embodiment, the number of bits included in the first field is related to a size of an activated UL BWP or a total number of Resource block groups (RBGs) of the UL BWP.

In one embodiment, the first field is a Frequency domain resource assignment field.

In one embodiment, the first field is a field that is used for frequency domain resource allocation.

In one embodiment, the statement “being used to determine the waveform for the first wireless channel” in the present application and “being used to indicate a waveform for the first wireless channel” are equivalent or interchangeable.

In one embodiment, the statement “being used to determine the waveform for the first wireless channel” in the present application and “explicitly indicating a waveform for the first wireless channel” are equivalent or interchangeable.

In one embodiment, the statement “being used to determine the waveform for the first wireless channel” in the present application and “implicitly indicating a waveform for the first wireless channel” are equivalent or interchangeable.

In one embodiment, the statement “being used to determine the waveform for the first wireless channel” in the present application and “being used to indicate whether transform precoding is enabled” are equivalent or interchangeable.

In one embodiment, the statement “being used to determine the waveform for the first wireless channel” in the present application and “being used to indicate whether the waveform for the first wireless channel is a DFT-s-OFDM waveform or a CP-OFDM waveform” are equivalent or interchangeable.

In one embodiment, the statement “being used to determine the waveform for the first wireless channel” in the present application and “being used to indicate the waveform for the first wireless channel” are equivalent or interchangeable.

In one embodiment, the statement “being used to determine the waveform for the first wireless channel” in the present application and “explicitly indicating the waveform for the first wireless channel” are equivalent or interchangeable.

In one embodiment, the statement “being used to determine the waveform for the first wireless channel” in the present application and “implicitly indicating the waveform for the first wireless channel” are equivalent or interchangeable.

In one embodiment, the statement “being used to determine the waveform for the first wireless channel” in the present application and “being used to indicate whether transform precoding is enabled” are equivalent or interchangeable.

In one embodiment, the statement in the present application that “the value of the first information denotes using resource allocation type 0” includes: the value of the first information being resourceAllocation Type0.

In one embodiment, the statement in the present application that “the value of the first information denotes using resource allocation type 1” includes: the value of the first information being resourceAllocationType1.

In one embodiment, the statement in the present application that “the value of the first information denotes a first field being used to indicate a resource allocation type” includes: the value of the first information being dynamicSwitch.

In one embodiment, the statement in the present application that “the value of the first information denotes a first field being used to indicate a resource allocation type” includes: the value of the first information indicating that the resource allocation type being used is indicated by the DCI.

In one embodiment, the statement in the present application that “the value of the first information denotes a first field being used to indicate a resource allocation type” includes: the value of the first information indicating that whether resource allocation type 0 or resource allocation type 1 is used is indicated by the DCI.

In one embodiment, the value of the first information is one of {resourceAllocation Type0, resourceAllocationType1, dynamicSwitch}.

In one embodiment, based on configuration of the first information, the resource allocation type used by the first wireless channel is resource allocation type 0, resource allocation type 1, or, alternatively, indicated by the first DCI.

In one embodiment, the resource allocation type in this application is for the frequency domain.

In one embodiment, the statement that “whether the first node supports the presence of a field in the first DCI being used to determine the waveform for the first wireless channel is related to a value of the first information; when the value of the first information denotes using resource allocation type 0: the first node does not support the presence of the field in the first DCI being used to determine the waveform for the first wireless channel” includes that
the first DCI belongs to DCIs of a first type: whether the first node supports the presence of a field in the DCIs of the first type being used to determine the waveform for the first wireless channel is related to a value of the first information; when the value of the first information denotes using resource allocation type 0: the first node does not support the presence of the field in the DCIs of the first type being used to determine the waveform for the first wireless channel.

### Embodiment 16

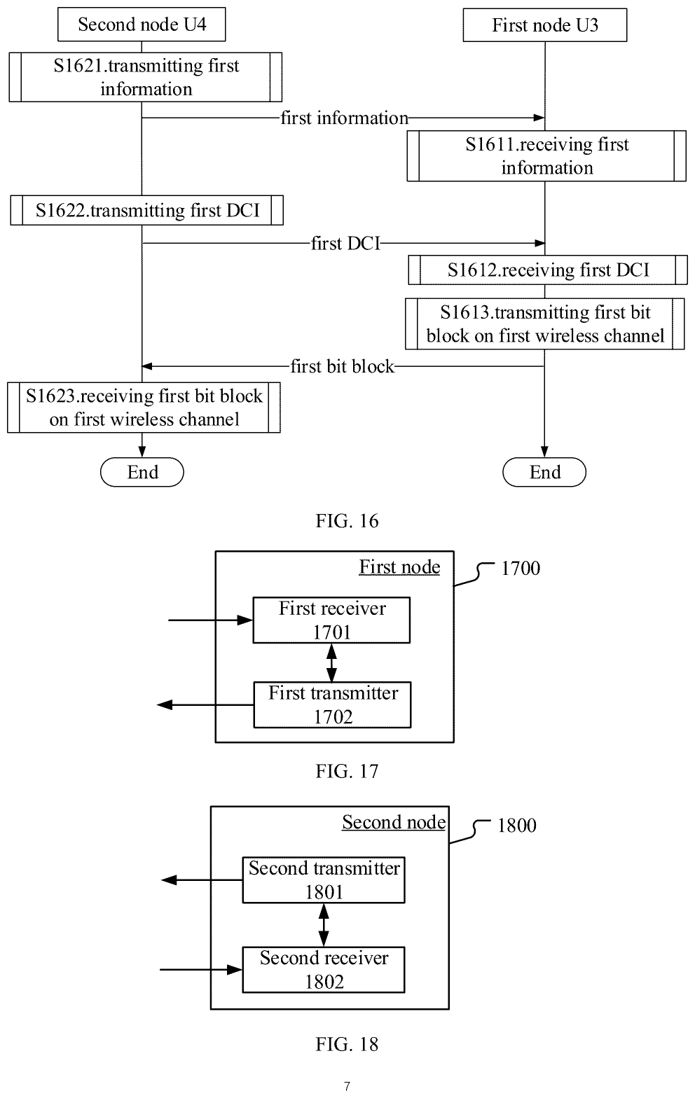

Embodiment 16 illustrates a flowchart of signal transmission according to one embodiment of the present application, as shown in FIG. 16. In FIG. 16, a first node U3 and a second node U4 are in communications via an air interface.

The first node U3 receives first information in step S1611; receives a first DCI in step S1612; and transmits a first bit block on a first wireless channel in step S1613.

The second node U4 transmits first information in step S1621; transmits a first DCI in step S1622; and receives a first bit block on a first wireless channel in step S1623.

In Embodiment 16, the first DCI is used to schedule the first wireless channel; the first information is used to determine a resource allocation type used for the first wireless channel; whether the first node U3 supports the presence of a field in the first DCI being used to determine the waveform for the first wireless channel is related to a value of the first information; when the value of the first information denotes using resource allocation type 0: the first node U3 does not support the presence of the field in the first DCI being used to determine the waveform for the first wireless channel; the first DCI comprises a first field, the first field in the first DCI being used to determine a frequency-domain resource occupied by the first wireless channel; when the value of the first information indicates the use of resource allocation type 1: the first node U3 supports the existence of a field in the first DCI being used to determine the waveform for the first wireless channel.

In one subembodiment of Embodiment 16, the first DCI belongs to DCIs of a first type: whether the first node U3 supports the presence of a field in the DCIs of the first type being used to determine the waveform for the first wireless channel is related to a value of the first information; when the value of the first information denotes using resource allocation type 0: the first node U3 does not support the presence of the field in the DCIs of the first type being used to determine the waveform for the first wireless channel.

In one subembodiment of Embodiment 16, when the value of the first information denotes a first field being used to indicate a resource allocation type: the first node U3 supports the presence of the field in the first DCI being used to determine the waveform for the first wireless channel.

In one subembodiment of Embodiment 16, when the value of the first information denotes a first field being used to indicate a resource allocation type: the first node U3 does not support the presence of the field in the first DCI being used to determine the waveform for the first wireless channel.

In one embodiment, when the value of the first information denotes using resource allocation type 1: the first node U3 supports the presence of the field in the DCIs of the first type being used to determine the waveform for the first wireless channel.

In one embodiment, when the value of the first information denotes a first field being used to indicate a resource allocation type: the first node U3 supports the presence of the field in the DCIs of the first type being used to determine the waveform for the first wireless channel.

In one embodiment, when the value of the first information denotes a first field being used to indicate a resource allocation type: the first node U3 does not support the presence of the field in the DCIs of the first type being used to determine the waveform for the first wireless channel.

In one embodiment, the first node U3 is the first node in the present application.

In one embodiment, the second node U4 is the second node in the present application.

In one embodiment, the first node U3 is a UE.

In one embodiment, the first node U3 is a base station.

In one embodiment, the second node U4 is a base station.

In one embodiment, the second node U4 is a UE.

In one embodiment, an air interface between the second node U4 and the first node U3 is a Uu interface.

In one embodiment, an air interface between the second node U4 and the first node U3 includes a cellular link.

In one embodiment, an air interface between the second node U4 and the first node U3 is a PC5 interface.

In one embodiment, an air interface between the second node U4 and the first node U3 includes a sidelink.

In one embodiment, an air interface between the second node U4 and the first node U3 includes a radio interface between a base station and a UE.

In one embodiment, an air interface between the second node U4 and the first node U3 includes a radio interface between a satellite device and a UE.

In one embodiment, an air interface between the second node U4 and the first node U3 includes a radio interface between a UE and another UE.

In one embodiment, DCIs that use DCI format 0_1 all belong to the DCIs of the first type.

In one embodiment, DCIs that use DCI format 0_2 all belong to the DCIs of the first type.

In one embodiment, the problem to be solved by the present application includes: how to avoid the occurrence of inappropriate {physical layer waveform, frequency-domain allocation type} combinations.

In one embodiment, the problem to be solved by the present application includes: how to avoid the degradation of communication performance caused by the adoption of an inappropriate combination of {physical layer waveform, frequency domain allocation type}.

In one embodiment, the problem to be solved by the present application includes: how to avoid the occurrence of inappropriate {physical layer waveform, frequency domain allocation type} combinations while ensuring sufficient scheduling flexibility.

### Embodiment 17

Embodiment 17 illustrates a structure block diagram of a processing device in a first node, as shown in FIG. 17. In FIG. 17, a first node processing device 1700 comprises a first receiver 1701 and a first transmitter 1702.

In one embodiment, the first node 1700 is a base station.

In one embodiment, the first node 1700 is a UE.

In one embodiment, the first node 1700 is a relay node.

In one embodiment, the first node 1700 is vehicle-mounted communication equipment.

In one embodiment, the first node 1700 is a UE supporting V2X communications.

In one embodiment, the first node 1700 is a relay node supporting V2X communications.

In one embodiment, the first node 1700 is a UE supporting dynamic waveform switching.

In one embodiment, the first node 1700 is a UE supporting operations on shared spectrum.

In one embodiment, the first receiver 1701 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1701 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1701 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1701 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1701 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1702 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1702 comprises at least the first five of the antenna 452, the transmitter 454, the multi-antenna transmitting processor 457, the transmitting processor 468, the controller/processor 459 the memory 460 and the data source 467 in FIG. 4 of the present application.

In one embodiment, the first transmitter 1702 comprises at least the first four of the antenna 452, the transmitter 454, the multi-antenna transmitting processor 457, the transmitting processor 468, the controller/processor 459 the memory 460 and the data source 467 in FIG. 4 of the present application.

In one embodiment, the first transmitter 1702 comprises at least the first three of the antenna 452, the transmitter 454, the multi-antenna transmitting processor 457, the transmitting processor 468, the controller/processor 459 the memory 460 and the data source 467 in FIG. 4 of the present application.

In one embodiment, the first transmitter 1702 comprises at least the first two of the antenna 452, the transmitter 454, the multi-antenna transmitting processor 457, the transmitting processor 468, the controller/processor 459 the memory 460 and the data source 467 in FIG. 4 of the present application.

In one embodiment, the first receiver 1701 receives first information and a first DCI, the first DCI comprising a first field: the first transmitter 1702 transmits a first bit block on a first wireless channel; herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one embodiment, the first information is used to determine whether the first DCI comprises a second field: when the first DCI comprises the second field: the second field in the first DCI is related to the method of indication of the first field in the first DCI and is used to determine the waveform for the first wireless channel.

In one embodiment, the first DCI comprises a first field group, the first field group comprising at least one field, and the first information is used to determine whether the first field group in the first DCI is used to determine the waveform for the first wireless channel; when the first field group in the first DCI is used to determine the waveform for the first wireless channel, the first field group in the first DCI is related to the method of indication of the first field in the first DCI; when the first field group in the first DCI is not used to determine the waveform for the first wireless channel, the first field group in the first DCI is independent of the method of indication of the first field in the first DCI.

In one embodiment, the first field group in the first DCI comprises a target bit group, and at least one bit in each field included in the first field group in the first DCI belongs to the target bit group; when the first field group in the first DCI is determined to be used for indicating the waveform for the first wireless channel and a value of the target bit group belongs to a first candidate value subset, the method of indication of the first field in the first DCI is a first method of indication; when the first field group in the first DCI is determined to be used for indicating the waveform for the first wireless channel and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one embodiment, when the first field group in the first DCI is determined to be used for indicating the waveform for the first wireless channel and the value of the target bit group belongs to a second candidate value subset, the waveform for the first wireless channel is a first waveform; when the first field group in the first DCI is determined to be used for indicating the waveform for the first wireless channel and the value of the target bit group does not belong to the second candidate value subset, the waveform for the first wireless channel is a second waveform; the first waveform and the second waveform are different physical layer waveforms, respectively, the second candidate value subset being a non-empty proper subset of the first candidate value set; the second candidate value subset is a non-empty proper subset of the first candidate value subset, or the first candidate value subset is a non-empty proper subset of the second candidate value subset.

In one embodiment, the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information belongs to the first parameter value subset, the first field group in the first DCI is related to the method of indication of the first field in the first DCI; when the value of the first information does not belong to the first parameter value subset, the first field group in the first DCI is independent of the method of indication of the first field in the first DCI.

In one embodiment, the first field group in the first DCI comprises a target bit group, and at least one bit in each field included in the first field group in the first DCI belongs to the target bit group; a first given parameter value is one parameter value in the first parameter value subset; when the value of the first information is the first given parameter value and a value of the target bit group belongs to a first candidate value subset, the method of indication of the first field in the first DCI is a first method of indication; when the value of the first information is the first given parameter value and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one embodiment, the first receiver 1701 receives first information and a first DCI, the first DCI comprising a first field: the first transmitter 1702 transmits a first bit block on a first wireless channel; herein, the first DCI is used to schedule the first wireless channel, the first field in the first DCI being used to determine one of a frequency-domain resource occupied by the first wireless channel or a Modulation and Coding Scheme (MCS) for the first wireless channel; a mes-TableDCI-0-2 field in a pusch-Config signaling received by the first node in this application is set to qam256, the first DCI is DCI format 0_2, the CRC of the first DCI is scrambled by C-RNTI or SP-CSI-RNTI, and the first node is not configured with MCS-C-RNTI, the first information is mcs-Table TransformPrecoderDCI-0-2 in the pusch-Config signaling; the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information belongs to the first parameter value subset, the first field group in the first DCI is related to the method of indication of the first field in the first DCI; when the value of the first information does not belong to the first parameter value subset, the first field group in the first DCI is independent of the method of indication of the first field in the first DCI.

In one subembodiment of the above embodiment, the first field group in the first DCI comprises a target bit group, and at least one bit in each field included in the first field group in the first DCI belongs to the target bit group; a first given parameter value is one parameter value in the first parameter value subset; when the value of the first information is the first given parameter value and a value of the target bit group belongs to a first candidate value subset, the method of indication of the first field in the first DCI is a first method of indication; when the value of the first information is the first given parameter value and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one embodiment, the first receiver 1701 receives first information and a first DCI; the first transmitter 1702 transmits a first bit block on a first wireless channel; herein, the first DCI is used to schedule the first wireless channel; the first information is used to determine a resource allocation type used for the first wireless channel; whether the first node supports the presence of a field in the first DCI being used to determine the waveform for the first wireless channel is related to a value of the first information; when the value of the first information denotes using resource allocation type 0: the first node does not support the presence of the field in the first DCI being used to determine the waveform for the first wireless channel.

In one embodiment, the first DCI comprises a first field, the first field in the first DCI being used to determine frequency-domain resources occupied by the first wireless channel.

In one embodiment, the first DCI belongs to DCIs of a first type: whether the first node supports the presence of a field in the DCIs of the first type being used to determine the waveform for the first wireless channel is related to a value of the first information: when the value of the first information denotes using resource allocation type 0: the first node does not support the presence of the field in the DCIs of the first type being used to determine the waveform for the first wireless channel.

In one embodiment, DCIs that use DCI format 0_1 all belong to the DCIs of the first type.

In one embodiment, DCIs that use DCI format 0_2 all belong to the DCIs of the first type.

In one embodiment, when the value of the first information denotes using resource allocation type 1: the first node supports the presence of the field in the first DCI being used to determine the waveform for the first wireless channel.

In one embodiment, when the value of the first information denotes a first field being used to indicate a resource allocation type: the first node supports the presence of the field in the first DCI being used to determine the waveform for the first wireless channel.

In one embodiment, when the value of the first information denotes a first field being used to indicate a resource allocation type: the first node does not support the presence of the field in the first DCI being used to determine the waveform for the first wireless channel.

In one embodiment, when the value of the first information denotes using resource allocation type 1: the first node supports the presence of the field in the DCIs of the first type being used to determine the waveform for the first wireless channel.

In one embodiment, when the value of the first information denotes a first field being used to indicate a resource allocation type: the first node supports the presence of the field in the DCIs of the first type being used to determine the waveform for the first wireless channel.

In one embodiment, when the value of the first information denotes a first field being used to indicate a resource allocation type: the first node does not support the presence of the field in the DCIs of the first type being used to determine the waveform for the first wireless channel.

### Embodiment 18

Embodiment 18 illustrates a structure block diagram a processing device in a second node according to one embodiment of the present application, as shown in FIG. 18. In FIG. 18, a second node processing device 1800 comprises a second transmitter 1801 and a second receiver 1802.

In one embodiment, the second node 1800 is a UE.

In one embodiment, the second node 1800 is a base station.

In one embodiment, the second node 1800 is satellite equipment.

In one embodiment, the second node 1800 is a relay node.

In one embodiment, the second node 1800 is vehicle-mounted communication equipment.

In one embodiment, the second node 1800 is UE supporting V2X communications.

In one embodiment, the second node 1800 is a UE supporting dynamic waveform switching.

In one embodiment, the second node 1800 is a device supporting operations on shared spectrum.

In one embodiment, the second transmitter 1801 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1801 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1801 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1801 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1801 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1802 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1802 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1802 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1802 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1802 comprises at least the first two of the antenna 420, the receiver 418, the multi-antenna receiving processor 472, the receiving processor 470, the controller/processor 475 and the memory 476 in FIG. 4 of the present application.

In one embodiment, the second transmitter 1801 transmits first information and a first DCI, the first DCI comprising a first field: the second receiver 1802 receives a first bit block on a first wireless channel; herein, the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

In one embodiment, the first information is used to determine whether the first DCI comprises a second field; when the first DCI comprises the second field: the second field in the first DCI is related to the method of indication of the first field in the first DCI and is used to determine the waveform for the first wireless channel.

In one embodiment, the first DCI comprises a first field group, the first field group comprising at least one field, and the first information is used to determine whether the first field group in the first DCI is used to determine the waveform for the first wireless channel; when the first field group in the first DCI is used to determine the waveform for the first wireless channel, the first field group in the first DCI is related to the method of indication of the first field in the first DCI; when the first field group in the first DCI is not used to determine the waveform for the first wireless channel, the first field group in the first DCI is independent of the method of indication of the first field in the first DCI.

In one embodiment, the first field group in the first DCI comprises a target bit group, and at least one bit in each field included in the first field group in the first DCI belongs to the target bit group; when the first field group in the first DCI is determined to be used for indicating the waveform for the first wireless channel and a value of the target bit group belongs to a first candidate value subset, the method of indication of the first field in the first DCI is a first method of indication; when the first field group in the first DCI is determined to be used for indicating the waveform for the first wireless channel and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

In one embodiment, when the first field group in the first DCI is determined to be used for indicating the waveform for the first wireless channel and the value of the target bit group belongs to a second candidate value subset, the waveform for the first wireless channel is a first waveform; when the first field group in the first DCI is determined to be used for indicating the waveform for the first wireless channel and the value of the target bit group does not belong to the second candidate value subset, the waveform for the first wireless channel is a second waveform; the first waveform and the second waveform are different physical layer waveforms, respectively, the second candidate value subset being a non-empty proper subset of the first candidate value set; the second candidate value subset is a non-empty proper subset of the first candidate value subset, or the first candidate value subset is a non-empty proper subset of the second candidate value subset.

In one embodiment, the first DCI comprises a first field group, the first field group comprising at least one field, and the first field group in the first DCI is used to determine the waveform for the first wireless channel; a first parameter value set consists of multiple candidate parameter values, and a first parameter value subset is a non-empty proper subset of the first parameter value set, a value of the first information being one parameter value in the first parameter value set; when the value of the first information belongs to the first parameter value subset, the first field group in the first DCI is related to the method of indication of the first field in the first DCI; when the value of the first information does not belong to the first parameter value subset, the first field group in the first DCI is independent of the method of indication of the first field in the first DCI.

In one embodiment, the first field group in the first DCI comprises a target bit group, and at least one bit in each field included in the first field group in the first DCI belongs to the target bit group; a first given parameter value is one parameter value in the first parameter value subset; when the value of the first information is the first given parameter value and a value of the target bit group belongs to a first candidate value subset, the method of indication of the first field in the first DCI is a first method of indication; when the value of the first information is the first given parameter value and the value of the target bit group does not belong to the first candidate value subset, the method of indication of the first field in the first DCI is a second method of indication; a first candidate value set is a part of a range of values of the target bit group, and the first candidate value subset is a non-empty proper subset of the first candidate value set, the first method of indication being different from the second method of indication.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station in the present application includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving first information and a first DCI, the first DCI comprising a first field; and
a first transmitter, transmitting a first bit block on a first wireless channel;
wherein the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

2. The first node according to claim 1, characterized in that the first information is used to determine whether the first DCI comprises a second field; when the first DCI comprises the second field: the second field in the first DCI is related to the method of indication of the first field in the first DCI and is used to determine the waveform for the first wireless channel.

3. The first node according to claim 1, characterized in that the method of indication of the first field in the first DCI comprises: whether the first field in the first DCI is used to indicate a frequency-domain resource in accordance with resource allocation type 0 or resource allocation type 1.

4. The first node according to claim 2, characterized in that the first field is a Frequency domain resource assignment field.

5. The first node according to claim 4, characterized in that when the first DCI comprises the second field and a value of the second field in the first DCI belongs to a target candidate value subset; a MSB of the first field in the first DCI is used to indicate a frequency-domain resource allocation type: a first candidate value set is a range of values of the second field, the target candidate value subset being a non-empty proper subset of the first candidate value set;
when the first DCI comprises the second field and the value of the second field in the first DCI does not belong to the target candidate value subset; a value of the MSB of the first field in the first DCI is fixed and set to 1.

6. The first node according to claim 5, characterized in that the second field comprises only one bit, the first candidate value set comprises 0 and 1, and the target candidate value subset only comprises 1.

7. The first node according to claim 6, characterized in that in a configuration signaling received by the first node, a higher layer parameter resourceAllocation is configured as dynamicSwitch.

8. A second node for wireless communications, comprising:
a second transmitter, transmitting first information and a first DCI, the first DCI comprising a first field; and
a second receiver, receiving a first bit block on a first wireless channel;
wherein the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

9. The second node according to claim 8, characterized in that the first information is used to determine whether the first DCI comprises a second field; when the first DCI comprises the second field: the second field in the first DCI is related to the method of indication of the first field in the first DCI and is used to determine the waveform for the first wireless channel.

10. The second node according to claim 8, characterized in that the method of indication of the first field in the first DCI comprises: whether the first field in the first DCI is used to indicate a frequency-domain resource in accordance with resource allocation type 0 or resource allocation type 1.

11. The second node according to claim 9, characterized in that the first field is a Frequency domain resource assignment field.

12. The second node according to claim 11, characterized in that when the first DCI comprises the second field and a value of the second field in the first DCI belongs to a target candidate value subset; a MSB of the first field in the first DCI is used to indicate a frequency-domain resource allocation type: a first candidate value set is a range of values of the second field, the target candidate value subset being a non-empty proper subset of the first candidate value set;
when the first DCI comprises the second field and the value of the second field in the first DCI does not belong to the target candidate value subset; a value of the MSB of the first field in the first DCI is fixed and set to 1.

13. The second node according to claim 12, characterized in that the second field comprises only one bit, the first candidate value set comprises 0 and 1, and the target candidate value subset only comprises 1.

14. A method in a first node for wireless communications, comprising:
receiving first information and a first DCI, the first DCI comprising a first field; and
transmitting a first bit block on a first wireless channel;
wherein the first DCI is used to schedule the first wireless channel, the first field in the first DCI being used to determine one of a frequency-domain resource occupied by the first wireless channel or a Modulation and Coding Scheme (MCS) for the first wireless channel; the first information is used to determine whether there is a field in the first DCI that is related to a method of indication of the first field in the first DCI and is used to determine a waveform for the first wireless channel.

15. The method in the first node according to claim 14, characterized in that the first information is used to determine whether the first DCI comprises a second field; when the first DCI comprises the second field: the second field in the first DCI is related to the method of indication of the first field in the first DCI and is used to determine the waveform for the first wireless channel.

16. The method in the first node according to claim 14, characterized in that the method of indication of the first field in the first DCI comprises: whether the first field in the first DCI is used to indicate a frequency-domain resource in accordance with resource allocation type 0 or resource allocation type 1.

17. The method in the first node according to claim 15, characterized in that the first field is a Frequency domain resource assignment field.

18. The method in the first node according to claim 17, characterized in that when the first DCI comprises the second field and a value of the second field in the first DCI belongs to a target candidate value subset; a MSB of the first field in the first DCI is used to indicate a frequency-domain resource allocation type: a first candidate value set is a range of values of the second field, the target candidate value subset being a non-empty proper subset of the first candidate value set;
when the first DCI comprises the second field and the value of the second field in the first DCI does not belong to the target candidate value subset; a value of the MSB of the first field in the first DCI is fixed and set to 1.

19. The method in the first node according to claim 18, characterized in that the second field comprises only one bit, the first candidate value set comprises 0 and 1, and the target candidate value subset only comprises 1.

20. The method in the first node according to claim 19, characterized in that in a configuration signaling received by the first node, a higher layer parameter resourceAllocation is configured as dynamicSwitch.
